(19) United States
(12) Patent Application Publication
(10) Pub. No.: US 2013/0061609 A1
(43) Pub. Date: Mar. 14, 2013

(54) CRYOPUMP AND METHOD OF MANUFACTURING THE SAME

(71) Applicant: Tsutomu FUKUDA, Tokyo (JP)

(72) Inventor: Tsutomu FUKUDA, Tokyo (JP)

(73) Assignee: SUMITOMO HEAVY INDUSTRIES, LTD., Tokyo (JP)

(21) Appl. No.: 13/458,751

(22) Filed: Apr. 27, 2012

(30) Foreign Application Priority Data
May 12, 2011 (JP) 2011-107670

(51) Int. Cl. B01D 8/00; B23P 13/00

(52) U.S. Cl. 62/55.5; 29/888.02

(57) ABSTRACT

A cryopump includes an array of cryosorption panels which are surrounded by a cryopump inner open space opened to a cryopump opening and a radiation shield which surrounds the cryopump inner open space. At least one of the cryosorption panels includes a front panel surface divided into an adsorption region of a non-condensable gas and a condensation region of a condensable gas.

### BACKGROUND OF THE INVENTION

1. Field of the Invention

The present invention relates to a cryopump and a method of manufacturing the same.

2. Description of the Related Art

A cryopump is a vacuum pump which captures gas molecules by condensation or adsorption on a cryopanel cooled to an extremely low temperature and thus evacuates the gas molecules. The cryopump is generally used to realize a clean vacuum environment which is demanded in a semiconductor circuit manufacturing process and the like. As one of exemplary applications of the cryopump, for example in an ion implantation process, most of gases to be evacuated may be a non-condensable gas such as hydrogen. The non-condensable gas may be evacuated only through the adsorption to an adsorption region which is cooled to an extremely low temperature.

### SUMMARY OF THE INVENTION

According to an aspect of the invention, there is provided a cryopump including: a refrigerator including a first cooling stage providing a first cooling temperature and a second cooling stage providing a second cooling temperature for adsorption of a non-condensable gas, the second temperature lower than the first temperature; a radiation shield including a shield end forming a gas receiving opening, the radiation shield thermally connected to the first cooling stage and surrounding the second cooling stage; and a cryopanel assembly thermally connected to the second cooling stage and forming an open space to the opening between the radiation shield and a peripheral portion of the assembly, at least a part of the assembly being visible from the shield end. The cryopanel assembly includes: a top panel facing the opening; and an intermediate panel disposed opposite to the opening with respect to the top panel and including a front surface directed to the opening. A peripheral part of an adjacent cryopanel facing the front surface of the intermediate panel and a portion of the front surface facing the peripheral part extend toward the radiation shield in the open space in substantially parallel with each other. The front surface is divided into an adsorption region of a non-condensable gas and a condensation region of a condensable gas.

According to an aspect of the invention, there is provided a cryopump including: a radiation shield; and a cryopanel assembly including a plurality of cryopanels arranged inside the radiation shield toward a bottom thereof, the assembly forming an open space connected to a radiation shield opening between peripheral parts of the plurality of cryopanels and the radiation shield. The cryopump has at least a 30% capture probability of hydrogen. Each of the plurality of cryopanels includes a cryopanel base to support an adsorbent thereon, the adsorbent capable of adsorbing hydrogen, the cryopanel base having at most a 30% area of a total surface of the cryopanel base from which the adsorbent is absent, such that an improved pumping efficiency of hydrogen, the efficiency defined as a ratio between a hydrogen pumping speed and an adsorbent area of the cryopump, is obtained compared to a case where the total surface of the cryopanel base would be covered entirely with the adsorbent.

According to another aspect of the invention, there is provided a method of manufacturing a cryopump. The method includes: obtaining a value of a panel structure parameter to provide a maximal pumping speed of hydrogen during a change of the panel structure parameter under a condition that a part of a surface of a cryosorption panel from which an adsorbent is absent is arranged; and determining a configuration of a cryosorption panel arrangement based on the value of the panel structure parameter.

### BRIEF DESCRIPTION OF THE DRAWINGS

FIG. 1 is a diagram schematically illustrating an ion implantation apparatus and a cryopump according to an embodiment of the invention;

FIG. 2 is a cross-sectional view schematically illustrating the cryopump according to an embodiment of the invention;

FIG. 3 is a plan view schematically illustrating the cryopump according to a preferred embodiment;

FIG. 4 is a cross-sectional view schematically illustrating the cryopump according to a preferred embodiment;

FIG. 5 is a diagram illustrating an adsorption region which is formed on a cryopanel relating to the cryopump illustrated in FIG. 4;

FIG. 6 is a plan view illustrating a front panel surface of the cryopanel relating to the cryopump illustrated in FIGS. 4 and 5;

FIG. 7 is a diagram illustrating a rear surface of the cryopanel illustrated in FIG. 6;

FIG. 8 is a table illustrating an example of an adsorbent deficiency rate or an adsorbent coating rate of a cryopanel assembly according to an embodiment of the invention;

FIG. 9 is a table illustrating an example of the adsorbent deficiency rate or the adsorbent coating rate of the cryopanel assembly according to an embodiment of the invention;

FIG. 10 is a diagram illustrating a change in the hydrogen pumping speed of the cryopump through regenerations according to an embodiment of the invention;

FIG. 11 is a flowchart illustrating a method of manufacturing a cryopump according to an embodiment of the invention; and

FIG. 12 is a flowchart illustrating the method of manufacturing a cryopump according to an embodiment of the invention.

### DETAILED DESCRIPTION OF THE INVENTION

The invention will now be described by reference to the preferred embodiments. This does not intend to limit the scope of the present invention, but to exemplify the invention.

In an aspect of the invention, it is one of exemplary objects to provide a cryopump which rapidly evacuates a non-condensable gas such as hydrogen and a method of manufacturing the cryopump.

A cryopump according to an aspect of the invention includes an exposed cryosorption panel arrangement. The panel arrangement includes a region from which an adsorbent, for example charcoal, is absent. Such an adsorbent-free region is arranged in a portion visible from a cryopump opening or in any other portion of the panel arrangement. Most of the panel surface and the adsorbent thereon are arranged so as not to be directly visible from the cryopump opening by being covered by an adjacent panel, and thus the adsorbent visible rate from the cryopump opening may be zero or a small value. The adsorbent is exposed to an open space which surrounds the panel arrangement. The adsorbent-free area is formed on the same surface as an adsorbent-placed area, that is, a region on which the adsorbent is present. The boundary of the adsorbent-free area is defined by the adsorbent. In other words, an individual panel surface is divided into the adsorbent-free area and the adsorbent-placed area.

Such a hybrid configuration of the exposed and non-exposed adsorbent helps high speed evacuation of the non-condensable gas and protection of the adsorbent from a hardly regenerated gas as well. The protection allows the cryopump to maintain a stable pumping performance through the repetition of the regenerating process several times. Further, a decrease in the visible rate due to the deficiency of adsorbent from the cryosorption panel helps to provide a cryopump which improves the pumping efficiency of the non-condensable gas and further excellently saves energy.

In a typical purpose of the cryopump, a condensable gas and a small amount of a non-condensable gas are contained in the gas to be evacuated. In order to prevent degradation in the adsorption performance of the non-condensable gas on a cryosorption panel or an adsorption panel that is caused by the accumulation of an ice layer of the condensable gas thereon, the cryopump for the typical purpose is arranged to hide the cryosorption panel or the adsorption panel with a cryocondensation panel or a condensation panel. The typical cryosorption panel is formed as a surface which is entirely covered with charcoal.

For example, a certain cryopanel structure has a double structure in which a cryocondensation panel capturing a condensable gas is provided at the outside thereof and a cryosorption panel capturing a non-condensable gas is provided at the inside thereof. In another cryopanel structure, a front surface directed to a cryopump opening is provided for cryocondensation, and a cryosorption surface is provided on its back. In a structure where a cryopanel includes a bent portion at the end portion thereof which is defined by a folding line, the entire area of one of the surfaces of the cryopanel excluding the surface of the bent portion may be covered by charcoal. Alternatively, the entire area including the surface of the bent portion may be covered by charcoal.

In general, the cryocondensation panel and the cryosorption panel are both cooled to a common cooling temperature, for example, an extremely low temperature from 10K to 20 K. The cryocondensation panel and the cryosorption panel are surrounded by a radiation shield or a radiant shield which protects them from a radiant heat. The radiation shield is cooled to a cooling temperature higher than those of the cryocondensation panel and the cryosorption panel, for example, an extremely low temperature from 80 K to 100 K. The radiation shield may be regarded as a cryopanel which provides an extremely low temperature surface with a relatively high temperature.

In some applications of a cryopump, condensation of a condensable gas on a cryogenic surface may not be dominant. For example, a cryopump for an ion implantation apparatus may be exemplified. In this application, an amount of the gas used in the apparatus to be condensed on a low-temperature cryopanel is small, and the main purpose of the cryopump is to evacuate a non-condensable gas (for example, hydrogen). Accordingly, it is desirable to facilitate reception of the non-condensable gas by exposing the cryosorption panel toward the cryopump opening. The high pumping speed may therefore be realized.

The improvement in the pumping speed due to the exposure contributes to a decrease in the area of the cryosorption panel for realizing a certain demanded pumping speed. This is because the gas satisfactorily flows to the adsorbent due to the exposure and the pumping speed per each unit area of the panel increases. As a result, the necessary area of the panel is decreased, and the weight of the cryopanel structure is also decreased.

A decrease in panel weight shortens the time necessary for a regenerating process of the cryopump. Since the cryopump is a so-called storage type vacuum pump, the regenerating process which discharges a gas accumulated in the pump to the outside at an appropriate interval is performed. The regeneration is a process in which the temperature of a cryopanel increases to a temperature higher than the operation temperature of the cryopanel (for example, a room temperature), a gas condensed or adsorbed on the panel surface is discharged again, to the outside, and the temperature is cooled to the operation temperature of the cryopanel again. One of large factors determining the regeneration time is a time necessary for re-cooling. The re-cooling time is concerned with the weight of the panel structure. The re-cooling time is shortened with a decrease in weight of the panel structure, and hence the regeneration time is shortened.

In general, the gas which is accumulated in the cryopump is substantially completely discharged by the regenerating process, and the cryopump is recovered to the pumping performance according to the specification when the regeneration is completed. However, some constituents in the accumulated gas may significantly remain in the adsorbent even after the regenerating process.

For example, in a cryopump for evacuation of an ion implantation apparatus, it is observed that an adhesive material adheres to an adsorbent such as charcoal. It is difficult to completely remove the adhesive material even after the regenerating process. It is considered that the adhesive material may be caused by an organic outgas which is discharged from a photoresist coating on a substrate to be processed. Alternatively, the adhesive material may be caused by a toxic gas which is used as a dopant gas, that is, a precursor gas in the ion implantation process. Also, the adhesive material may be caused by any other by-product gas in the ion implantation process. These gases may be complexly concerned with each other so that the adhesive material is generated.

In an ion implantation process, most of gases which are evacuated by the cryopump may be a hydrogen gas. The hydrogen gas is substantially completely discharged to the outside through the regeneration. A small amount of hardly regenerated gas may not severely affect the cryopump pumping performance during every cryopumping process. However, when the cryopumping process and the regenerating process are repeated, the hardly regenerated gas is gradually accumulated onto the adsorbent, which may degrade the pumping performance. In the case that the pumping performance is lower than an allowable range, replacement of the adsorbent and/or the cryopanel may be required. Alternatively, a maintenance work including a chemical process of removing the hardly regenerated gas from the adsorbent may be required.

Therefore, a cryopump according to an aspect of the invention includes an exposed arrangement of cryosorption panels, part of which an adsorbent (for example, charcoal) is absent. A cryopump inner open space is provided around the exposed arrangement. The inner open space is opened to a cryopump opening. The inner open space is surrounded by the radiation shield. An open local space is defined by the adjacent cryosorption panels of the cryosorption panel arrangement, and the local space is opened to an outer space of the cryopump through the cryopump inner open space. The openness of the cryosorption panel arrangement promotes a gas to reach the panel surfaces and thereby assists high speed evacuation of a non-condensable gas (for example, hydrogen) using the cryopump.

In an embodiment, an adsorbent-free portion is set as a region in a cryosorption panel. The region is visible from the outside of the cryopump through the cryopump opening. The adsorbent-free portion may be provided in a distal end of the cryosorption panel which protrudes toward the cryopump inner open space and faces the radiation shield. The adsorbent-free portion may be used as the cryocondensation panel.

In this way, direct exposure of the adsorbent toward the cryopump opening can be prevented. Namely, the adsorbent visible rate from the cryopump opening may be made to be very small. Accordingly, it is possible to prevent or reduce the effect on the adsorbent caused by the hardly regenerated gas contained in a gas entering the cryopump. The hardly regenerated gas is collected on the cryocondensation panel, and the accumulation of the adhesive material to the adsorbent is reduced. In this way, it is possible to protect the adsorbent from the hardly regenerated gas, which may lead to rapid evacuation of the non-condensable gas.

An exemplary cryopump according to this technical concept is a cryopump which is suitable for use in an evacuation system of an ion implantation apparatus. Further, another example thereof is a cryopump which is suitable for use in an evacuation system of a substrate processing device. The substrate processing device processes, for example, a resist-coated substrate with a process gas.

Here, a hardly regenerated gas means, for example, a gas which is not completely discharged to the outside of the cryopump at a time point in which a predetermined gas (for example, hydrogen) is substantially completely discharged to the outside of the cryopump in a predetermined regenerating process. Further, the hardly regenerated gas may mean a gas which remains in the adsorbent more than a reference amount even after the regenerating process which is conditioned to substantially completely discharge a predetermined gas to the outside of the cryopump. The residual amounts of e.g., an organic outgas from a resist coating or any other coating on a wafer surface which remains in the adsorbent after the regenerating process may be large. Further, a toxic dopant gas which is used in the ion implantation process also may be the hardly regenerated gas.

The resist (for example, an organic resist) is made of an organic material. The process gas may be a reactive process gas which chemically and directly reacts with an object to be processed (for example, a substrate) or with a resist on the surface thereof. Alternatively, the process gas may be a gas which assists the reactive gas so as to be introduced into the processed object. When the substrate processing device is a sputtering apparatus, the process gas is an inert gas, for example, argon. When the substrate processing device is an ion implantation apparatus, the process gas is, for example, a hydrogen gas or a dopant gas. Due to the interaction of the process gas and the resist during the process, the organic gas may be emitted from the resist. Further, the outgas may be emitted from the resist due to the vacuum environment even during a period out of the process. The organic gas may include, for example, aromatic series, straight-chain hydrocarbon, alcohol, ketone, ether, and the like.

The hardly regenerated gas is not limited to the organic gas from the resist or the dopant gas used in the ion implantation process. For example, the hardly regenerated gas may be the process gas itself used in some processes. Further, the hardly regenerated gas may be a gas which is emitted from a coating on the substrate other than the resist.

According to an embodiment, a cryopump may include: a refrigerator which includes a first cooling stage providing a first cooling temperature and a second cooling stage providing a second cooling temperature, being lower than the first cooling temperature, to adsorb a non-condensable gas; a radiation shield which includes a front shield end forming a gas receiving opening, is thermally connected to the first cooling stage, and surrounds the second cooling stage; and a cryopanel assembly which is thermally connected to the second cooling stage and forms an open space connected to the shield opening between an outer peripheral portion thereof and the radiation shield. At least a part of the cryopanel assembly may be visible from the front shield end.

The cryopanel assembly may include: a top panel which faces to a shield opening; and an intermediate panel which includes a front panel surface directed to the shield opening and is disposed opposite to the shield opening with respect to the top panel. An open recess which is continuous to the open space may be formed between the front panel surface of the intermediate panel and an adjacent cryopanel facing the front panel surface. A depth of the open recess may be larger than a gap between the adjacent cryopanel and the front panel surface.

The intermediate panel may include an adsorption region of a non-condensable gas on the front panel surface. The adsorption region may be arranged inside a boundary which is defined by an intersection between the front panel surface and a direct line of sight from the shield end to a distal end of the adjacent cryopanel. The adsorption region may occupy an internal zone inside the boundary on the front panel surface.

The intermediate panel may include a condensation region of a condensable gas thereon. The condensation region may include an external zone outside the boundary on the front panel surface.

A peripheral part of the intermediate panel may extend substantially parallel to the top panel. The peripheral part of the intermediate panel may lie closer to the radiation shield than a peripheral part of the top panel. The intermediate panel may include a plurality of plates arranged in parallel with each other. Each of the plates may include a front face directed to the shield opening and a rear face directed opposite to the opening.

The cryopanel assembly may include a lower panel disposed opposite to the shield opening with respect to the intermediate panel. A peripheral part of the lower panel may extend substantially parallel to the intermediate panel. The peripheral part of the lower panel may lie closer to the radiation shield than the peripheral part of the intermediate panel.

The cryopump may include a louver thermally connected to the radiation shield and disposed in the shield opening. The louver may have a medium size between the sizes of the top panel and the intermediate panel. An open region may be formed between an outer end of the louver and the radiation shield.

At least a 70% surface area of the intermediate panel may be covered by an adsorbent for adsorption of hydrogen. The cryopump may have at least a 30% capture probability of hydrogen. The adsorbent may be accommodated in the open recess. An adsorbent visible rate that is defined as a ratio of an adsorbent area visible from the shield opening with respect to a gross area of the adsorbent on the cryopanel assembly is less than 7%.

According to an embodiment, a cryopump may include: a radiation shield; and a cryopanel assembly which includes an array of a plurality of cryopanels arranged inward from the front inside the radiation shield. Each of the plurality of cryopanels may include a front surface directed to an opening of the radiation shield and a rear surface directed opposite to the opening. An open space connected to the opening may be formed between outer peripheral parts of the plurality of cryopanels and the radiation shield. The cryopanel assembly may be configured such that at least 70% of a total area of the front and rear surfaces of the plurality of cryopanels is covered by an adsorbent capable of adsorbing hydrogen and such that the cryopump has at least a 30% capture probability of hydrogen. The adsorbent may be accommodated between the rear surface of each of the plurality of cryopanels and the front surface of an inner cryopanel inwardly adjacent thereto. An adsorbent visible rate that is defined as a ratio of an adsorbent area visible from the shield opening with respect to a gross area of the adsorbent on the plurality of cryopanels may be less than 7%.

The array of the plurality of cryopanels may be arranged such that at least apart of the inner cryopanel is optically shielded or covered by a frontal cryopanel with respect to the shield opening. The frontal cryopanel may be outwardly adjacent to the inner cryopanel. The adsorbent may be provided in a covered portion of the inner cryopanel so as to be invisible from the shield opening.

The gross area of the adsorbent may be 90% or less of the total area of the front and rear surfaces of the plurality of cryopanels.

At least 90% of the adsorbent may be exposed to the radiation shield or the opening.

According to an embodiment, a cryopump may include: an array of cryosorption panels surrounded by a cryopump inner open space opened to a cryopump opening; and a radiation shield surrounding the cryopump inner open space. At least one of the cryosorption panels may include a panel end protruding toward the radiation shield in the cryopump inner open space. The panel end may include a region from which an adsorbent is absent, that is, an adsorbent-free region.

The adsorbent-free region and a region on which the adsorbent is present, that is, an adsorbent-placed region, may be formed on a common surface. The adsorbent-free region may be formed in a manner such that a surface of a cryopanel base is exposed for cryocondensation. The adsorbent-free region may be in an exposed peripheral edge portion which is visible through the cryopump opening.

According to an embodiment, a method of manufacturing a cryopump may include: masking a base of a cryopanel; and attaching an adsorbent to an unmasked surface of the base. The masking may include masking an exposed portion of the base which is not covered or shielded by another cryopanel. The method may include determining a region to be masked on a cryopanel of an array of cryopanels. The region to be masked may be outside a boundary that is defined by an intersection between the cryopanel and a direct line of sight from a front end of a radiation shield to a periphery of another cryopanel adjacent to the cryopanel.

According to an embodiment, a cryopump may include: a refrigerator which includes a first cooling stage providing a first cooling temperature and a second cooling stage providing a second cooling temperature, being lower than the first cooling temperature, to adsorb a non-condensable gas; a radiation shield which includes a front shield end forming a gas receiving opening, is thermally connected to the first cooling stage, and surrounds the second cooling stage; and a cryopanel assembly which is thermally connected to the second cooling stage and forms an open space connected to the shield opening between an outer peripheral portion thereof and the radiation shield. At least a part of the cryopanel assembly may be visible from the front shield end.

The cryopanel assembly may include: a top panel facing the shield opening; and an intermediate panel disposed opposite to the shield opening with respect to the top panel and including a front panel surface directed to the opening. A peripheral part of an adjacent cryopanel facing the front panel surface of the intermediate panel and a portion of the front panel surface facing the peripheral part may extend toward the radiation shield in the open space in substantially parallel with each other. The front panel surface may be divided into an adsorption region of a non-condensable gas and a condensation region of a condensable gas. A peripheral part of the front panel surface may be divided into the adsorption region of the non-condensable gas and the condensation region of the condensable gas.

The adjacent cryopanel may be the top panel. A peripheral part of the intermediate panel may extend closer to the radiation shield than the peripheral part of the top panel. Each of the top panel and the intermediate panel may include a plurality of plates arranged in parallel with each other. Each plate may include a front face directed to the shield opening and a rear face directed opposite to the opening. A dimension of the plates of the intermediate panel may be larger than that of the plates of the top panel.

The cryopanel assembly may further include a lower panel disposed opposite to the shield opening with respect to the intermediate panel. A peripheral part of the lower panel may extend substantially parallel to the intermediate panel. The peripheral part of the lower panel may lie closer to the radiation shield than the peripheral part of the intermediate panel. The lower panel may include a plurality of plates arranged in parallel with each other. Each plate may include a front face directed to the shield opening and a rear face directed opposite to the opening. A dimension of the plates of the lower panel may be larger than that of the plates of the intermediate panel.

An open recess which is continuous to the open space may be formed between the portion of the front panel surface of the intermediate panel and the peripheral part of the adjacent cryopanel. A depth of the open recess may be larger than a gap between the adjacent cryopanel and the front panel surface.

The cryopump may include a louver thermally connected to the radiation shield and disposed in the shield opening. The louver may have a medium size between the sizes of the top panel and the intermediate panel. An open region may be formed between an outer end of the louver and the radiation shield.

The cryopump may have at least a 30% capture probability of hydrogen. The intermediate panel may include a cryopanel base to support an adsorbent thereon, the adsorbent capable of adsorbing hydrogen, the cryopanel base having at most a 30% area of a total surface of the cryopanel base from which the adsorbent is absent, such that an improved pumping efficiency of hydrogen, the efficiency defined as a ratio between a hydrogen pumping speed and an adsorbent area of the cryopump, is obtained compared to a case where the total surface of the cryopanel base would be covered entirely with the adsorbent.

According to an embodiment, a cryopump may include: a radiation shield; and a cryopanel assembly including a plurality of cryopanels arranged inside the radiation shield toward a bottom thereof, the assembly forming an open space connected to a radiation shield opening between peripheral parts of the plurality of cryopanels and the radiation shield. The cryopump may have at least a 30% capture probability of hydrogen. Each of the plurality of cryopanels may include a cryopanel base to support an adsorbent thereon, the adsorbent capable of adsorbing hydrogen, the cryopanel base having at most a 30% area of a total surface of the cryopanel base from which the adsorbent is absent, such that an improved pumping efficiency of hydrogen, the efficiency defined as a ratio between a hydrogen pumping speed and an adsorbent area of the cryopump, is obtained compared to a case where the total surface of the cryopanel base would be covered entirely with the adsorbent.

The pumping efficiency of hydrogen may be 5×10⁻² L/s·mm² or more. At least a 10% area of the total surface of the cryopanel base may be an adsorbent-free region. At least 90% of the adsorbent may be exposed to the radiation shield or the opening.

The method according to an embodiment may include: obtaining a value of a panel structure parameter to provide a maximal pumping speed of hydrogen during a change of the panel structure parameter under a condition that a surface of a cryosorption panel part of which an adsorbent is absent is arranged; and determining a configuration of a cryosorption panel arrangement based on the value of the panel structure parameter. The panel structure parameter may include a dimension of the cryosorption panel.

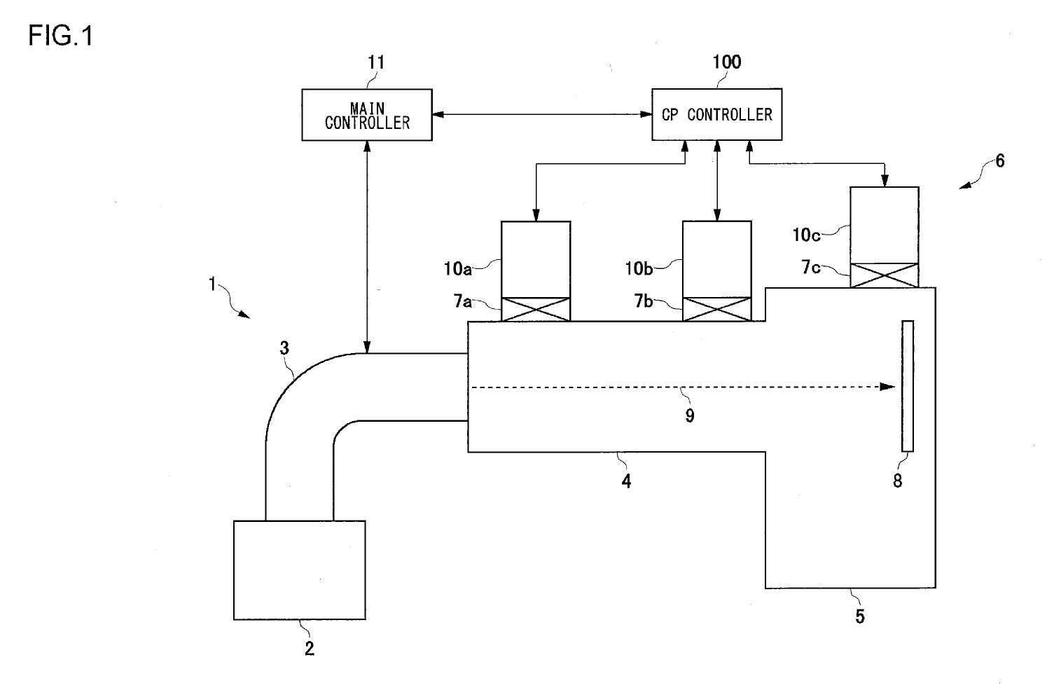

FIG. 1 is a diagram schematically illustrating an ion implantation apparatus 1 and a cryopump 10 according to an embodiment of the invention. An ion implantation apparatus 1, which is an example of a beam irradiating apparatus used to irradiate a beam to a target, includes an ion source unit 2, a mass analyzer 3, a beam line unit 4, and an end station unit 5.

The ion source unit 2 is configured to ionize an element to be implanted onto a surface of a substrate and output the ionized element as an ion beam. The mass analyzer 3 is provided at the downstream of the ion source unit 2, and is configured to select necessary ions from the ion beam.

The beam line unit 4 is provided at the downstream of the mass analyzer 3, and includes a lens system which shapes the ion beam and a scanning system which scans the ion beam over the substrate. The end station unit 5 is provided at the downstream of the beam line unit 4, and includes a substrate holder (not illustrated) which holds a substrate 8 corresponding to an ion implantation process target, that is, an irradiation target, a driving system which drives the substrate 8 with respect to the ion beam, and the like. A beam path 9 in the beam line unit 4 and the end station unit 5 is schematically indicated by a dashed arrow.

Further, the ion implantation apparatus 1 is provided with an evacuation system 6. The evacuation system 6 is provided so as to maintain a desired high vacuum (for example, a high vacuum of about 10⁻⁵ Pa) from the ion source unit 2 to the end station unit 5. The evacuation system 6 includes cryopumps 10a, 10b, and 10c.

For example, the cryopumps 10a and 10b are attached to the cryopump attachment opening of the vacuum chamber wall surface of the beam line unit 4 for the purpose of the evacuation in the vacuum chamber of the beam line unit 4. The cryopump 10c is attached to the cryopump attachment opening of the vacuum chamber wall surface of the end station unit 5 for the purpose of the evacuation in the vacuum chamber of the end station unit 5. Furthermore, the evacuation system 6 may be formed such that both the beam line unit 4 and the end station unit 5 are evacuated by one cryopump 10. Further, the evacuation system 6 may be formed such that the beam line unit 4 and the end station unit 5 are respectively evacuated by the plurality of cryopumps 10.

The cryopumps 10a and 10b are attached to the beam line unit 4 on gate valves 7a and 7b, respectively. The cryopump 10c is attached to the end station unit 5 on a gate valve 7c. Furthermore, in the following description, the cryopumps 10a, 10b, and 10c are collectively referred to as the cryopump 10, and the gate valves 7a, 7b, and 7c collectively referred to as the gate valve 7. During the operation of the ion implantation apparatus 1, the gate valve 7 is open and the evacuation using the cryopump 10 is performed. The gate valve 7 is closed when the cryopump 10 is regenerated.

Furthermore, the evacuation system 6 may further include a turbo-molecular pump and a dry pump which are used to maintain the ion source unit 2 in the high vacuum state. Further, the evacuation system 6 may include a roughing pump which is provided in parallel to the cryopump 10 so as to evacuate the beam line unit 4 and the end station unit 5 from the atmospheric pressure to the pressure at which the operation of the cryopump 10 is started.

The gas which is present in the beam line unit 4 and the end station unit 5 and the gas which is introduced thereinto are evacuated by the cryopump 10. Most of the gas to be evacuated is generally a hydrogen gas. The gas which includes the hydrogen gas is evacuated from the beam path 9 using the cryopanel of the cryopump 10. Further, the gas to be evacuated may include an emitted gas from a resist coated on a substrate, a dopant gas, or a by-product gas in the ion implantation process.

The ion implantation apparatus 1 includes a main controller 11 which controls the apparatus. Further, the cryopump 10 is provided with a cryopump controller (hereinafter, simply referred to as a “CP controller”) 100 which controls the cryopump 10. The main controller 11 may be regarded as an upper level controller which generally controls the cryopump 10 through the CP controller 100. The main controller 11 and the CP controller 100 respectively include a CPU which executes various calculation processes, ROM which stores various control programs, RAM which is used as a work area for storing data or executing a program, an input and output interface, memory, and the like. The main controller 11 and the CP controller 100 are connected to each other so as to be able to communicate with each other.

The CP controller 100 is provided separately from the cryopump 10, and controls each of the plurality of cryopumps 10. Each of the cryopumps 10a, 10b, and 10c may be provided with an IO module (not illustrated) which performs an input and output process while communicating with the CP controller 100. Furthermore, the CP controller 100 may be individually provided in each of the cryopumps 10a, 10b, and 10c.

The cryopump 10 for the ion implantation apparatus 1 mainly evacuates a hydrogen gas as described above. In order to improve the throughput of the ion implantation process of the ion implantation apparatus 1, it is desirable to provide the cryopump 10 which can rapidly evacuate a hydrogen gas. Further, it is desirable to provide the cryopump to improve the pumping efficiency of hydrogen and further have an excellent energy-saving performance. Therefore, the cryopump 10 includes an exposed cryosorption panel arrangement 14 having an adsorption region for a non-condensable gas. However, the adsorption region is formed so as not to be substantially exposed.

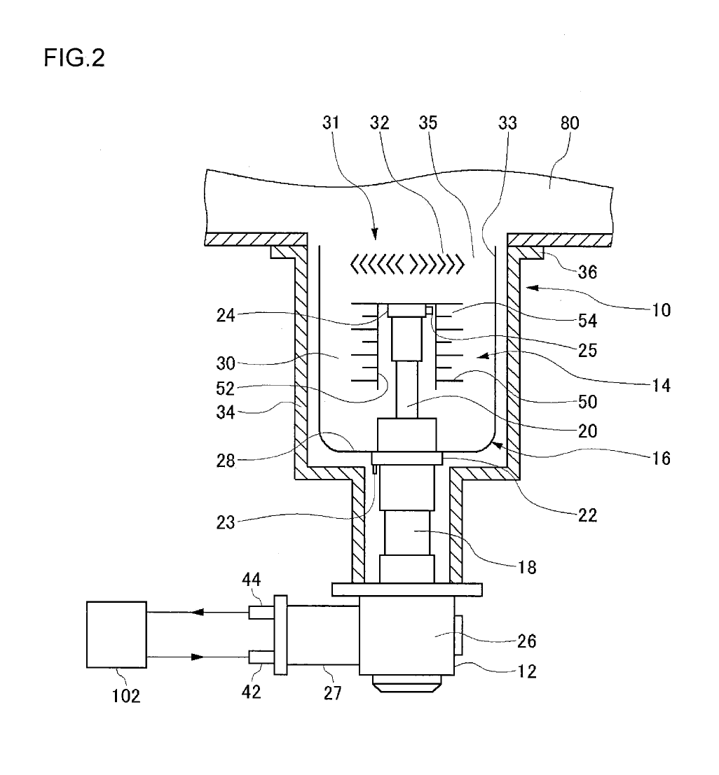

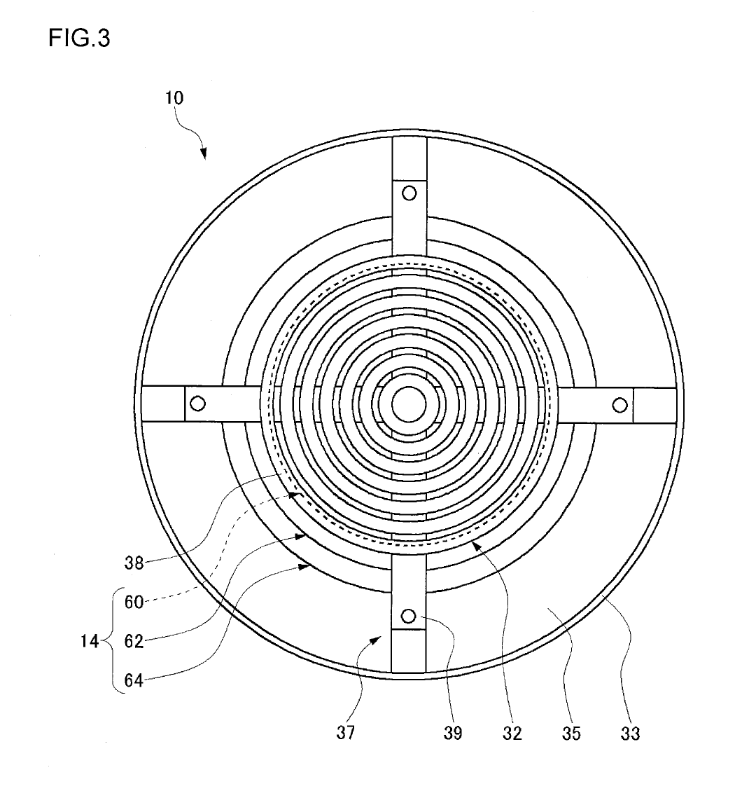

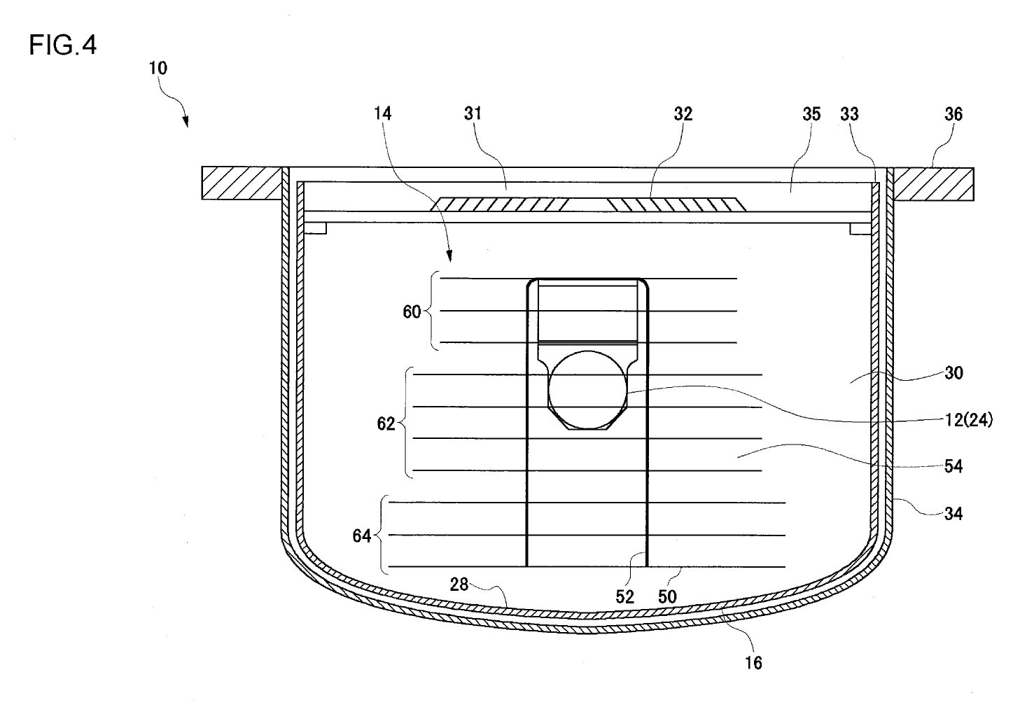

FIG. 2 is a cross-sectional view schematically illustrating the cryopump 10 according to an embodiment of the invention. FIG. 3 is a plan view illustrating the cryopump 10 according to the preferred embodiment. FIG. 4 is a cross-sectional view schematically illustrating the cryopump 10 according to the preferred embodiment.

The exposed cryopanel arrangement 14 forms a cryopump inner open space 30 which is opened to a cryopump opening 31 between the outer peripheral portion and the radiation shield 16. An open local space 54 is defined by adjacent cryopanels 50 of the cryopanel arrangement 14, and the local space 54 is continuous to the cryopump inner open space 30. The adsorption region is formed on the surface of the cryopanel 50 which surrounds the local space 54. The openness of the local space 54 promotes a gas to reach the adsorption region and assists a high speed evacuation of a non-condensable gas, e.g., hydrogen, using the cryopump 10.

At least a part of the open local space 54 is optically shielded by the adjacent cryopanel 50 from the cryopump opening 31, and the adsorption region is accommodated in the local space 54. Since the adsorption region is prevented to be directly exposed to the cryopump opening 31, the adsorption region is protected from a hardly regenerated gas which is contained in a gas entering the cryopump 10. In this way, it is possible to protect the adsorption region from the hardly regenerated gas in addition to the rapid evacuation of the non-condensable gas.

The cryopump 10 includes a first cryopanel which is cooled to a first cooling temperature level and a second cryopanel which is cooled to a second cooling temperature level lower than the first cooling temperature level. In the first cryopanel, a gas with a low vapor pressure at the first cooling temperature level is captured by condensation. For example, a gas with a vapor pressure which is lower than the reference vapor pressure (for example, 10⁻⁸ Pa) is evacuated.

In the second cryopanel which is a cryosorption panel, it captures by adsorption a non-condensable gas which does not condense even at the second temperature level due to a high vapor pressure. For this, the entire or most of the panel surface area is the adsorption region. The adsorption region is generated by, for example, providing an adsorbent on the panel surface. The adsorbent is, for example, charcoal. The adsorption region may be formed by, for example, an adsorbent such as zeolite which selectively adsorbs specific gas molecules or a porous surface layer formed on the panel base in this way. The non-condensable gas is adsorbed onto the adsorption region cooled to the second temperature level and is evacuated. The non-condensable gas contains hydrogen. When there is a gas with a low vapor pressure at a second cooling temperature level in an atmosphere, it is captured by condensation on the adsorbent of the cryosorption panel or on the surface lack of the adsorbent.

The cryopump 10 includes a refrigerator 12. The refrigerator 12 generates coldness through a thermal cycle in which an operating gas is supplied, expanded therein, and discharged. The refrigerator 12 is a Gifford-McMahon type refrigerator (a so-called GM refrigerator). Further, the refrigerator 12 is a double-stage-type refrigerator, and includes a first cylinder 18, a second cylinder 20, a first cooling stage 22, a second cooling stage 24, and a refrigerator motor 26. The first cylinder 18 and the second cylinder 20 are connected in series to each other, and a first displacer and a second displacer (not illustrated) which are connected to each other are incorporated therein. A refrigerant is mounted in the first displacer and the second displacer. Furthermore, the refrigerator 12 may be a refrigerator other than the double-stage GM refrigerator. For example, a single-stage GM refrigerator may be used or a pulse tube refrigerator or a Solvay refrigerator may be used.

The refrigerator 12 includes a passage switching mechanism which periodically switches the passageway of the operating gas so as to periodically repeat the inflow and the outflow of the operating gas. The passage switching mechanism includes, for example, a valve unit and a driving unit which drives the valve unit. The valve unit is, for example, a rotary valve, and the driving unit is a motor which rotates the rotary valve. The motor may be, for example, an AC motor and a DC motor. Further, the passage switching mechanism may be a direct drive mechanism which is driven by a linear motor.

One end of the first cylinder 18 is provided with a refrigerator motor 26. The refrigerator motor 26 is provided inside a motor housing 27 which is formed in the end portion of the first cylinder 18. The refrigerator motor 26 is connected to the first displacer and the second displacer so that the first displacer and the second displacer are respectively movable in a reciprocating manner inside the first cylinder 18 and the second cylinder 20. Further, the refrigerator motor 26 is connected to a movable valve (not illustrated) which is provided inside the motor housing 27 so that the movable valve is rotatable normally and reversely.

The first cooling stage 22 is provided in the end portion near the second cylinder 20 in the first cylinder 18, that is, the connection portion between the first cylinder 18 and the second cylinder 20. Further, the second cooling stage 24 is provided in the end of the second cylinder 20. The first cooling stage 22 and the second cooling stage 24 are respectively fixed to the first cylinder 18 and the second cylinder 20 by, for example, soldering.

The refrigerator 12 is connected to a compressor 102 through a gas supply port 42 and a gas discharge port 44 which are provided outside the motor housing 27. The refrigerator 12 generates coldness in the first cooling stage 22 and the second cooling stage 24 in a manner such that a high pressure operating gas (for example, helium or the like) which is supplied from the compressor 102 expands therein. The compressor 102 collects the operating gas expanding in the refrigerator 12, pressurizes the operating gas again, and supplies the operating gas to the refrigerator 12.

Specifically, first, a high pressure operating gas is supplied from the compressor 102 to the refrigerator 12. At this time, the refrigerator motor 26 drives the movable valve inside the motor housing 27 in a state where the gas supply port 42 communicates with the internal space of the refrigerator 12. When the internal space of the refrigerator 12 is filled with the high pressure operating gas, the movable valve is switched by the refrigerator motor 26, so that the internal space of the refrigerator 12 communicates with the gas discharge port 44. Accordingly, the operating gas expands and the expanding operating gas is collected by the compressor 102. In synchronization with the operation of the movable valve, the first displacer and the second displacer respectively move in a reciprocating manner inside the first cylinder 18 and the second cylinder 20. By repeating such a thermal cycle, the refrigerator 12 generates coldness in the first cooling stage 22 and the second cooling stage 24.

The second cooling stage 24 is cooled to a temperature lower than that of the first cooling stage 22. The second cooling stage 24 is cooled to, for example, a range from 10 K to 20 K or so, and the first cooling stage 22 is cooled to, for example, a range from 80 K to 100 K or so. A first temperature sensor 23 which measures the temperature of the first cooling stage 22 is attached to the first cooling stage 22, and a second temperature sensor 25 which measures the temperature of the second cooling stage 24 is attached to the second cooling stage 24.

The radiation shield 16 is fixed to the first cooling stage 22 of the refrigerator 12 while being thermally connected thereto, and the cryopanel assembly 14 is fixed to the second cooling stage 24 of the refrigerator 12 while being thermally connected thereto. For this reason, the radiation shield 16 is cooled to a temperature which is substantially equal to the temperature of the first cooling stage 22, and the cryopanel assembly 14 is cooled to a temperature which is substantially equal to the temperature of the second cooling stage 24.

The CP controller 100 (see FIG. 1) determines a control output based on a sensor output signal. The CP controller 100 determines, for example, the voltage and the frequency to be supplied to the refrigerator motor 26. The CP controller 100 controls an inverter (not illustrated) which is associated with the refrigerator motor 26. The inverter of the refrigerator motor adjusts electrical power of a prescribed voltage and a prescribed frequency supplied from, an external power supply, for example, a commercial power supply and supplies the adjusted electrical power to the refrigerator motor 26 in response to the command from the CP controller 100.

The CP controller 100 controls the refrigerator 12 based on, for example, the temperature of the cryopanel. The CP controller 100 transmits an operation command to the refrigerator 12 so that the actual temperature of the cryopanel follows a target temperature. For example, the CP controller 100 controls the operating frequency of the refrigerator motor 26 through a feed-back control so as to minimize a deviation between the target temperature of the first cryopanel and the measured temperature of the first temperature sensor 23. The frequency of thermal cycle of the refrigerator 12 is determined in accordance with the operating frequency of the refrigerator motor 26. The target temperature of the first cryopanel is determined as, for example, a specification in accordance with a process performed in the vacuum chamber 80. In this case, the second cooling stage 24 of the refrigerator 12 and the cryopanel assembly 14 are cooled to a temperature which is determined by the specification of the refrigerator 12 and the external thermal load.

When the measured temperature of the first temperature sensor 23 is higher than the target temperature, the CP controller 100 outputs a command value so that the operating frequency of the refrigerator motor 26 increases. The frequency of thermal cycle in the refrigerator 12 increases in synchronization with an increase in the motor operating frequency, and the first cooling stage 22 of the refrigerator 12 is cooled toward the target temperature. On the contrary, when the measured temperature of the first temperature sensor 23 is lower than the target temperature, the operating frequency of the refrigerator motor 26 decreases, and the temperature of the first cooling stage 22 of the refrigerator 12 increases toward the target temperature.

In general, the target temperature of the first cooling stage 22 is set to a constant value. Thus, the CP controller 100 outputs a command value so that the operating frequency of the refrigerator motor 26 increases when thermal load to the cryopump 10 increases, and outputs a command value so that the operating frequency of the refrigerator motor 26 decreases when thermal load to the cryopump 10 decreases. Furthermore, the target temperature may be appropriately changed. For example, the target temperature of the cryopanel may be sequentially set so that a target ambient pressure is realized in a volume to be evacuated (for example, the vacuum chamber 80). Further, the CP controller 100 may control the operating frequency of the refrigerator motor 26 so that the actual temperature of the second cryopanel matches the target temperature.

In a typical cryopump, the frequency of thermal cycle is set to be constant at all times. The operation mode is set so that the cryopump is operated at a comparatively large frequency so as to be rapidly cooled from the normal temperature to the pump operation temperature, and the temperature of the cryopanel is adjusted by the heating using a heater when the external thermal load is small. Thus, the power consumption increases. On the contrary, in the embodiment, since thermal cycle frequency is controlled in accordance with thermal load to the cryopump 10, the cryopump which has an excellent energy saving performance may be realized. Further, the fact that the heater does not need to be necessarily provided contributes to a reduction in the power consumption.

The cryopump 10 includes a cryopanel assembly or cryopanel structure 14. The cryopanel assembly 14 includes a plurality of cryopanels which are cooled by the second cooling stage 24 of the refrigerator 12. These panels are arranged from the front (i.e. from the opening) towards the bottom inside the radiation shield 16. Each cryopanel includes a front surface or face directed to the shield opening 31 and a rear surface or face directed opposite to the shield opening 31, that is, toward a blocking portion 28. The cryopanel assembly 14 may include a cryopanel directed to a side surface of the radiation shield 16 or a cryopanel (not illustrated) directed to any other direction. The panel surface is provided with a cryogenic surface which is used to capture a gas by condensation or adsorption and evacuate the gas. The surface of the cryopanel is generally provided with an adsorbent such as a charcoal for adsorbing a gas.

The cryopanel assembly 14 forms an inner space 30 which is opened toward the shield opening 31 between the outer peripheral portion and the radiation shield 16. In the cryopanel assembly 14, at least a part thereof, for example, the outer peripheral portion is visible from the front shield end 33. The cryopump 10 illustrated in FIG. 2 and the cryopump 10 illustrated in FIGS. 3 and 4 have different structures of the cryopanel assembly 14. The specific configuration of each cryopanel assembly 14 will be described later.

The cryopump 10 includes the radiation shield 16. The radiation shield 16 is provided so as to protect the cryopanel assembly 14 from the ambient radiant heat. The radiation shield 16 is formed in a bottomed cylindrical shape of which one end has the shield opening 31. The shield opening 31 is defined by the front shield end 33 of the radiation shield 16, for example, the inner surface of the end portion of the cylindrical side surface. The front shield end 33 forms an opening which receives a gas from the vacuum chamber 80 to the cryopanel assembly 14.

On the other hand, the blocking portion 28 is formed at the other end on the opposite side to the shield opening 31 of the radiation shield 16, that is, the bottom side of the pump. The blocking portion 28 is formed by a flange portion which extends radially inward from the bottom end of the cylindrical side surface of the radiation shield 16. Since the cryopump 10 illustrated in FIG. 2 is a vertical cryopump, the flange portion is attached to the first cooling stage 22 of the refrigerator 12. The refrigerator 12 protrudes toward the internal space 30 along the axis of the radiation shield 16, and the second cooling stage 24 is inserted into the internal space 30.

In the case of a so-called horizontal cryopump illustrated in FIG. 4, a second cooling stage 24 of the refrigerator is disposed so as to be inserted in a direction intersecting the axial direction of the radiation shield 16 (generally, an orthogonal direction, from back side toward the front side of the drawing paper of FIG. 4). In the case of the horizontal type, generally the blocking portion 28 is completely blocked. The refrigerator 12 is disposed so as to protrude toward the inner space 30 along a direction orthogonal to the axis of the radiation shield 16 from the refrigerator attachment opening portion which is formed in the side surface of the radiation shield 16. The first cooling stage 22 of the refrigerator 12 is attached to the refrigerator attachment opening portion of the radiation shield 16, and the second cooling stage 24 of the refrigerator 12 is disposed in the inner space 30. The cryopanel assembly 14 is attached to the second cooling stage 24. In this way, the cryopanel assembly 14 is disposed in the inner space 30 of the radiation shield 16.

Further, as illustrated in FIGS. 2 to 4, the shield opening 31 of the radiation shield 16 is provided with the baffle or a louver 32 which is thermally connected to the radiation shield 16. The louver 32 and the radiation shield 16 are coaxially disposed, and an annular open region 35 is formed between the outer peripheral portion of the louver 32 and the radiation shield 16. The louver 32 is provided so as to have a gap between the louver and the cryopanel assembly 14 in the axial direction of the radiation shield 16. Furthermore, the gate valve 7 (see FIG. 1) is provided between the louver 32 and the vacuum chamber 80.

As illustrated in FIG. 3, the louver 32 is attached to the radiation shield 16 by an attachment structure 37. The attachment structure 37 is provided at four positions at the interval of, for example, 90°. The attachment structure 37 mechanically fixes the louver 32 to the radiation shield 16, and serves as a heat transfer path from the radiation shield 16 to the louver 32.

The louver 32 is provided with a plurality of louver plates 38, and the respective louver plates 38 are formed so as to have conical side surfaces with different diameters and are arranged in a concentric shape. Although a gap is formed between the respective louver plates 38 in FIG. 3, the respective louver plates 38 may be densely arranged so that no gap is formed therebetween when seen from the upside in a state where the adjacent louver plates 38 overlap each other. Each louver plate 38 is attached to a cross-shaped support member 39, and the support member 39 is attached to an attachment structure 37. The louver 32 may be formed in, for example, a concentric shape or other shapes such as a lattice shape when seen from the side of the vacuum chamber 80.

The area of the open region 35 is set so that the hydrogen pumping speed using the cryopump 10 realizes the requirements. Specifically, for example, when the number of the louver plates 38 of the louver 32 is changed, the diameter of the louver 32 may be different and the area of the open region 35 may be adjusted accordingly. The exposed portion of the cryopanel assembly 14, for example, the peripheral edge portion which is not shielded by the louver 32 is seen from the outside through the open region 35.

The cryopump 10 is attached to the vacuum chamber 80 by a pump casing 34. The vacuum chamber 80 is, for example, a vacuum chamber of the beam line unit 4 or the end station unit 5 (see FIG. 1). The cryopump 10 is gastightly fixed to the evacuation opening of the vacuum chamber 80 through the flange portion 36 of the pump casing 34, and forms a gastight space which is integrated with the inner space of the vacuum chamber 80.

The pump casing 34 accommodates the radiation shield 16, the louver 32, the cryopanel assembly 14, and a first cooling stage 22 and a second cooling stage 24 of the refrigerator 12. The pump casing 34 and the radiation shield 16 are both formed in a cylindrical shape and are coaxially arranged. Since the inner diameter of the pump casing 34 is slightly larger than the outer diameter of the radiation shield 16, the radiation shield 16 is disposed so as to have a slight gap between the radiation shield and the inner surface of the pump casing 34.

The pump casing 34 is formed by connecting two cylinders with different diameters in series. The large-diameter cylinder end of the pump casing 34 is open, and the flange portion 36 which is connected to the vacuum chamber 80 extends outwardly in the radial direction. Accordingly, the large-diameter end of the pump casing 34 defines the cryopump opening 31 which is used to receive a gas from the outside of the cryopump, for example, the vacuum chamber 80. The small-diameter cylinder end of the pump casing 34 is fixed to a motor housing 27 of the refrigerator 12.

The cryopanel assembly 14 is disposed in the inner space 30 of the radiation shield 16. The cryopanel assembly 14 includes a plurality of cryopanels 50 and a panel attachment member 52. The cryopanel assembly 14 includes the combination of the cryopanels with different shapes and/or different diameters.

The panel attachment member 52 is a component which is used to arrange the plurality of cryopanels 50 in a fixed manner according to a designed panel layout and forms a heat transfer path from the second cooling stage 24 of the refrigerator 12 to each cryopanel 50. The panel attachment member 52 is a member which includes, for example, a bottom surface for the attachment to the second cooling stage 24 and a side surface for fixing the plurality of cryopanels 50. In the panel attachment member 52, the bottom surface faces the pump opening, and the side surface surrounds the second cooling stage 24.

The plurality of cryopanels 50 is arranged inwardly from the front side close to the shield opening 31. The respective cryopanels 50 extend toward the side surface of the radiation shield 16 so as to be parallel to each other. The cryopanels 50 are evenly arranged with the same interval between the adjacent cryopanels. The plurality of cryopanels 50 includes a plurality of large cryopanels and a plurality of small cryopanels. In an embodiment illustrated in FIGS. 3 and 4, a plurality of larger cryopanels is further provided. The small cryopanels are formed in a shape enveloped by the outer shapes of the large cryopanels. The outer peripheral end of the cryopanel protrudes in the radial direction from the axis of the shield toward the open space 30. The open space 30 spreads between the outer peripheral end of the cryopanel and the side surface of the radiation shield 16, and the open space 30 is directly continuous to the open region 35 around the periphery of the louver 32.

Hereinafter, the cryopanel which faces the cryopump opening 31 may be referred to as a top panel. That is, the cryopanel which is closest to the cryopump opening 31 is a top panel. Although the top panel is a large cryopanel in FIG. 2, the top panel may be a small cryopanel as illustrated in FIG. 4. Further, the top panel may be one cryopanel, or may collectively correspond to several cryopanels which are closest to the cryopump opening 31.

In the embodiment illustrated in FIG. 2, the large cryopanels and the small cryopanels are alternately arranged with a gap therebetween. That is, one of the small cryopanels is adjacent to a large cryopanel, and the next large cryopanel is adjacent to that small cryopanel. The outer peripheral ends of the large cryopanels extend to a position nearer the radiation shield 16 in relation to the outer peripheral ends of the small cryopanels. The louver 32 may be shaped in a medium size between the large cryopanels and the small cryopanels.

On the other hand, in the embodiment illustrated in FIGS. 3 and 4, the plurality of cryopanels 50 of the cryopanel assembly 14 are categorized into a plurality of groups according to the dimensions thereof, and the groups are arranged inwardly from the front side of the radiation shield 16.

In an embodiment, there are three divided groups from the first to third groups, arranged in the order that the more inner from the shield opening 31 becomes larger in size. Therefore, hereinafter, the cryopanel (s) of the first group may be referred to as a top panel or a small cryopanel 60, the cryopanel(s) of the second group may be referred to as an intermediate panel or a medium cryopanel 62, and the cryopanel(s) of the third group may be referred to as a lower panel or a large cryopanel 64. Furthermore, in an embodiment, the cryopanel assembly 14 may include two groups or more than three groups, instead of the three divided groups.

Each group includes at least one cryopanel, and desirably, each group includes a plurality of cryopanels. In an embodiment, each group includes two to five cryosorption panels, and the cryopanel assembly 14 includes eight to fourteen cryosorption panels in total. In FIG. 4, the number of small cryopanels 60, the number of medium cryopanels 62, and the number of large cryopanels 64 are respectively three, four, and three.

The medium cryopanel 62 is disposed at the opposite side to the shield opening 31 with respect to the small cryopanel 60. The large cryopanel 64 is disposed at the opposite side to the shield opening 31 with respect to the medium cryopanel 62. The outer peripheral portion of the medium cryopanel 62 extends to a position nearer the radiation shield 16 in relation to the outer peripheral portion of the small cryopanel 60 so as to be parallel to the small cryopanel 60. The outer peripheral portion of the large cryopanel 64 extends to a position nearer the radiation shield 16 in relation to the outer peripheral portion of the medium cryopanel 62 so as to be parallel to the medium cryopanel 62. As illustrated in FIG. 3, the louver 32 may have a medium size between the sizes of the small cryopanel 60 (which is depicted by the dashed line in FIG. 3) and the medium cryopanel 62.

In an embodiment, each cryopanel 50 has a disk shape. In this case, the plurality of cryopanels 50 includes a large-diameter disk panel, a small-diameter disk panel, and a medium-diameter disk panel shaped between the large and small disk panels. The louver 32 may be a disk-like louver with a medium diameter between the medium-diameter disk panel and the small-diameter disk panel. In the embodiment illustrated in FIG. 2, the louver 32 may be a disk-like louver with a medium diameter between the large-diameter disk panel and the small-diameter disk panel.

Each of the plurality of cryosorption panels 50 is, for example, a metallic plate which includes a front face or surface directed to the shield opening 31 or the louver 32 and a rear face or surface directed to the blocking portion 28 at the opposite side thereof. A charcoal adheres to the surfaces of the plate, thereby forming an adsorption region. Of the total area of the front and rear faces, for example, at least 50% thereof is the adsorption region, and the remainder, at most 50% is a non-adsorption region. The non-adsorption region is an adsorbent-free region in which the metallic surface of the plate is exposed without the adsorbent. The adsorbent-free region may serve as the condensation region.

The entire area of the rear surface of each cryopanel 50 may be the adsorption region, and at least a part of the front surface of the cryopanel 50 may be also the adsorption region. In the uppermost cryopanel, only the rear surface may be provided with the adsorption region. In the embodiment illustrated in FIG. 2, for example, the center portion of the front surface of at least a large cryopanel in the interior cryopanels 50 excluding the uppermost cryopanel may be the adsorption region, and the outer side may be the non-adsorption region or the condensation region. The entire area of the front surface of a small cryopanel among the interior cryopanels 50 may be the adsorption region. Even the entire area of the front surfaces of the lowermost several large cryopanels may be the adsorption region.

The boundary between the adsorption region and the non-adsorption region, that is, the boundary between the adsorbent-free region and the adsorbent-placed region may be defined by the locus of a direct line of sight which is projected to the front surface of the cryopanel. The line of sight is a straight line which is drawn from the front shield end 33 to the outer peripheral end of the cryopanel which is present adjacently at the right front position. That is, the intersection line between the line of sight and the front panel surface becomes the boundary line. The adsorption region is formed inside the boundary line, and desirably, the adsorption region occupies the inside of the boundary. Further, the condensation region includes a region on the outside of the boundary, and desirably, is limited to the outside of the boundary. In this way, the outer peripheral portion of the front surface of the cryopanel 50 is divided into the adsorption region and the condensation region.

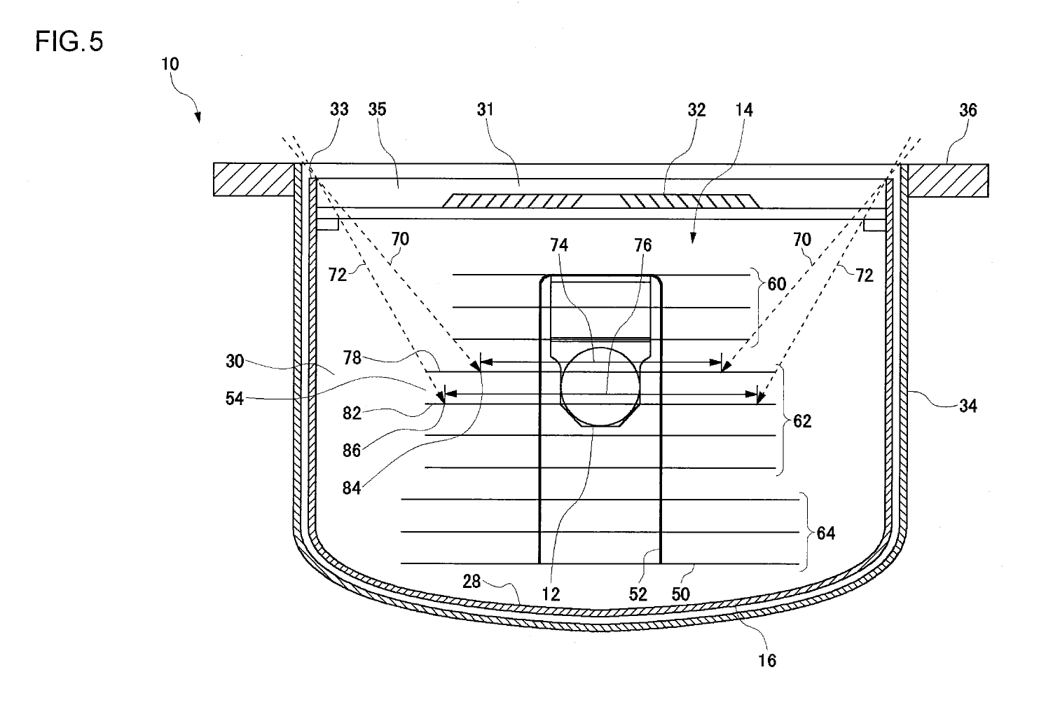

FIG. 5 is a diagram illustrating the adsorption region which is formed in the cryopanel 50 relating to the cryopump illustrated in FIG. 4. A first visual line 70 and a second visual line 72 from the front shield end 33 are depicted for description by dashed arrows of FIG. 5. The first visual line 70 is a direct line of sight to the outer end of the farthest one of the small cryopanels 60 away from the shield opening 31 or the front shield end 33. The second visual line 72 is a direct line of sight to the outer end of the closest one of the medium cryopanels 62 to the shield opening 31 or the front shield end 33. As described above, the small cryopanel 60 which is farthest from the shield opening 31 and the medium cryopanel 62 which is closest to the shield opening 31 are adjacent to each other.

The locus of the first visual line 70 in the front surface of the medium cryopanel 62 which is closest to the shield opening 31 makes a boundary 84 between an adsorption region 74 and a condensation region 78 in the front surface of the medium cryopanel 62. Further, the locus of the second visual line 72 in the front surface of the medium cryopanel 62 which is secondly closest to the shield opening 31 makes a boundary 86 between an adsorption region 76 and a condensation region 82 in the front surface of the second medium cryopanel 62. In this way, even in the other cryopanels, that is, the medium cryopanel 62, the small cryopanel 60, and the large cryopanel 64, a boundary between the adsorption region and the condensation region may be determined.

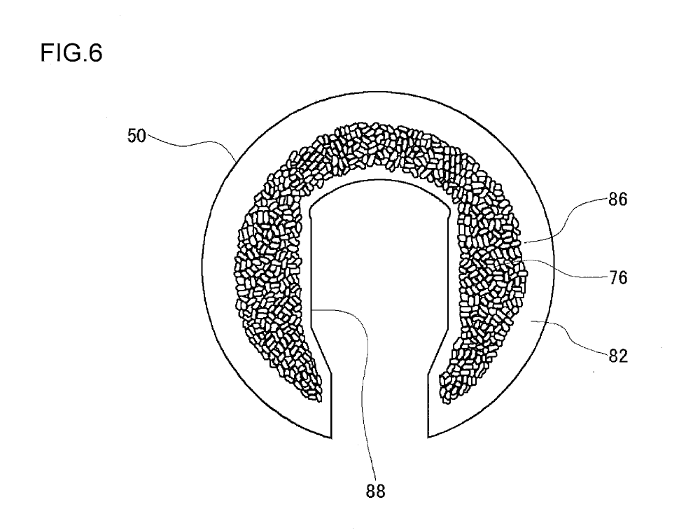

FIG. 6 is a plan view illustrating the front panel surface of the cryopanel 50 relating to the cryopump 10 illustrated in FIGS. 4 and 5. The cryopanel 50 is provided with a notch portion 88 which is formed from a part of the outer periphery of the cryopanel toward the center thereof so as to be used for the attachment to the panel attachment member 52. FIG. 6 illustrates a boundary line 86 which is determined by the second visual line 72 of FIG. 5 as an example. Since the shield opening 31 and the cryopanel 50 are formed in a circular shape, the boundary line 86 draws a circle in the front panel surface. In this case, the boundary line 86 indicates the radius limit for attachment of the adsorbent. When the adsorbent adheres to the entire area on the inside of the attachment radius limit, the largest amount of the adsorbent may be loaded on the front panel surface without exposing the adsorbent when seen from the shield opening 31.

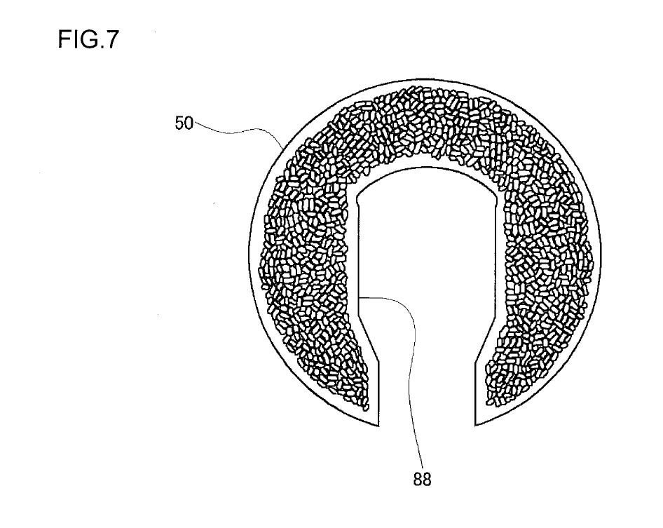

FIG. 7 is a diagram illustrating the rear surface of the cryopanel 50 illustrated in FIG. 6. As described above, even when the adsorbent adheres to the entire area of the rear panel surface, the outer peripheral end of the rear surface may be slightly empty as illustrated in FIG. 7. Such a narrow adsorbent-free region may ensure to avoid from being exposed to the shield opening 31, for example, in consideration of the height of particles of the adhering adsorbent (for example, a charcoal).

In this way, in the cryosorption panel 50, the adsorbent-free region and the adsorbent-placed region are formed on the common surface. The common surface is, for example, a plane, more specifically, the front panel surface or the rear panel surface. In the adsorbent-free region, a cryopanel base surface, for example, a metallic surface is exposed for cryocondensation. The adsorbent-free region is present in the exposed peripheral edge portion which is visible through the cryopump opening 31.

The particles of the charcoal adhering to the cryopanel 50 are formed in, for example, a cylindrical shape. The plurality of particles of the charcoal adheres to the surface of the cryopanel 50 according to the uneven arrangement while being densely arranged thereon. Furthermore, the shape of the adsorbent may not be a cylindrical shape, but may be, for example, a spherical shape, other molded shapes, or an irregular shape. The arrangement of the adsorbent on the panel may be an even arrangement or an uneven arrangement.

In the embodiment of FIGS. 2 and 4, at least 60% or at least 70% of the total area of the front and rear surfaces of the plurality of cryopanels 50 are covered by the adsorbent. Desirably, when the center portion of at least upper (opening-side) cryopanels 50 is formed as the adsorbent-placed region, at most 90% or at most 80% of the total area of the front and rear surfaces of the plurality of cryopanels 50 are covered by the adsorbent. A 65% to 85% area of the total area of the front and rear surfaces of the plurality of cryopanels 50 may be covered by the adsorbent.

Further, in the embodiment of FIGS. 2 and 4, at most 40% or at most 30% of the total area of the front and rear surfaces of the plurality of cryopanels 50 is the adsorbent-free region. Desirably, when the outer peripheral portion of at least upper (opening-side) cryopanels 50 is formed as the adsorbent-free region, at least 10% or at least 20% of the total area of the front and rear surfaces of the plurality of cryopanels 50 is the adsorbent-free region. A 15% to 35% area of the total area of the front and rear surfaces of the plurality of cryopanels 50 may be the adsorbent-free region.

Especially, in the cryopanel assembly 14 having the medium cryopanel 62, it is desirable that at least 60% or at least 70% of the total surface area of the medium cryopanel 62 is covered by the adsorbent. In the respective surfaces of the respective panels of the medium cryopanel 62, at least 60% or at least 70% thereof may be covered by the adsorbent. In both surfaces of each panel or the panels in total, at least 60% or at least 70% may be covered by the adsorbent. Further, when the outer peripheral portion is formed as the adsorbent-free region, it is desirable that 90% or less or 80% or less of the total surface area of the medium cryopanel 62 is covered by the adsorbent. More desirably, the medium cryopanel 62 has 65% to 85% of the adsorbent coating rate.

In this case, it is desirable that the small cryopanel 60 has an adsorbent coating rate which is equal to that of the medium cryopanel 62 or smaller than that of the medium cryopanel 62. For example, it is desirable that the small cryopanel 60 has 50% to 65% of the adsorbent coating rate. It is desirable that the large cryopanel 64 has an adsorbent coating rate which is equal to that of the medium cryopanel 62 or larger than that of the medium cryopanel 62. For example, it is desirable that the large cryopanel 64 has 85% to 100% of the adsorbent coating rate. The entire area of both surfaces of the large cryopanel 64 may be covered by the adsorbent.

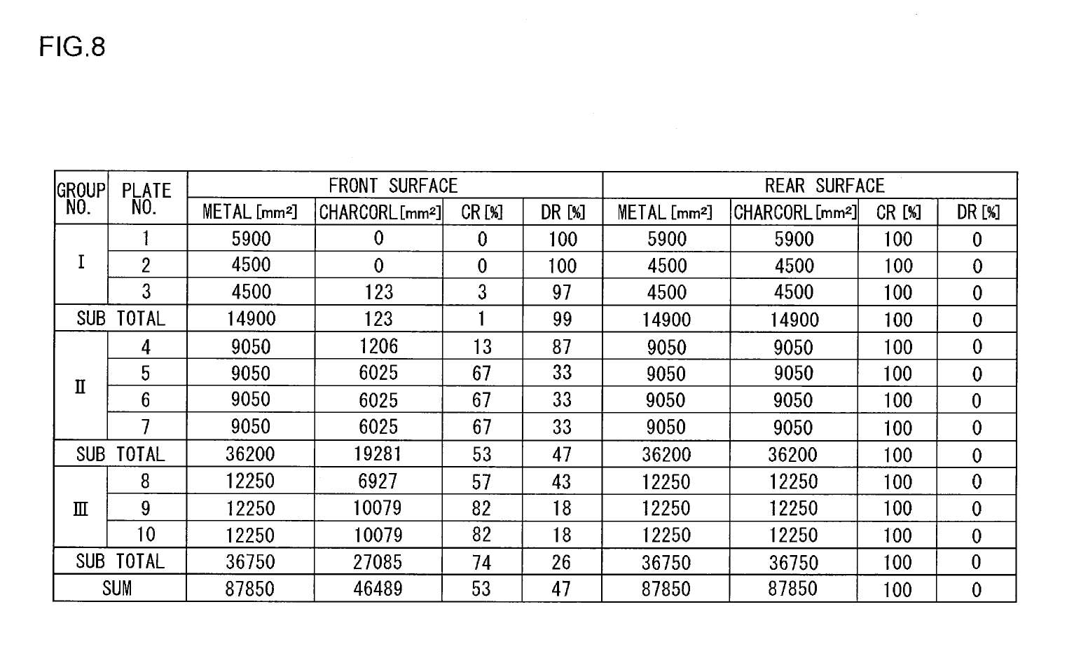

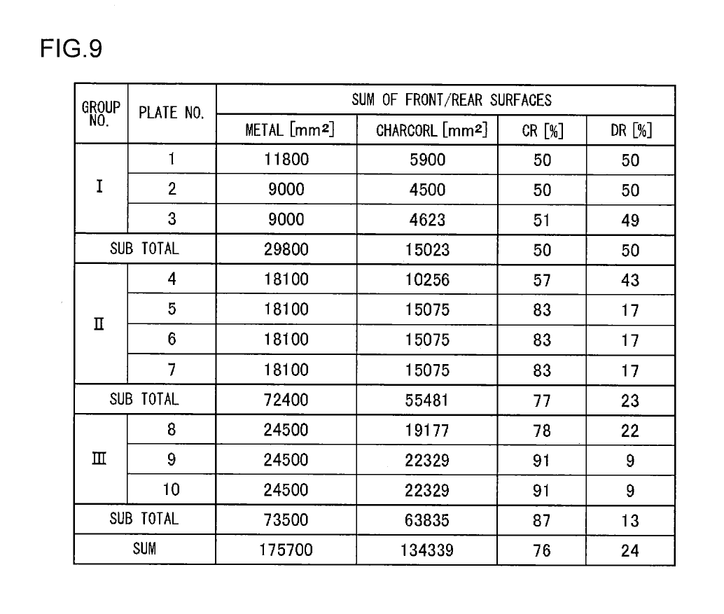

FIGS. 8 and 9 are tables illustrating an example of the adsorbent deficiency rate or the adsorbent coating rate of the cryopanel assembly 14 according to an embodiment of the invention. The tables illustrate the adsorbent deficiency rate and the adsorbent coating rate for each of the small cryopanel 60, the medium cryopanel 62, and the large cryopanel 64. Also, the tables illustrate the adsorbent deficiency rate and the adsorbent coating rate of both the individual plate and the group. FIG. 8 illustrates each of the front and rear surfaces, and FIG. 9 illustrates the sum of the front and rear surfaces.

In FIGS. 8 and 9, the small cryopanel 60, the medium cryopanel 62, the large cryopanel 64 are respectively indicated by the first group (Group I), the second group (Group II), and the third group (Group III). In an embodiment, the first, second and third groups respectively include three plates, four plates, and three plates, and totally ten plates are included in those groups. These plates are arranged in the same manner as the cryopanel assembly 14 illustrated in FIG. 4. In FIG. 8, the respective plates are indicated by the plate numbers 1 to 10.

In this embodiment, each plate is formed of metal, the adsorbent is a particle-like charcoal, and the charcoal adheres to the metallic surface by an adhesive. As illustrated in the column of METAL in FIG. 8, the areas of the metal portion of the front and rear surfaces of the individual plate are respectively indicated. As illustrated in the column of CHARCOAL in FIG. 8, the area of the charcoal portion is zero when the surface is not provided with the charcoal. the area of the charcoal portion is the same as the area of the metal portion when the entire area of the surface is covered by the charcoal. Further, it has a medium value when there is a region where the charcoal is absent. The ratio of the area of the charcoal portion to the area of the metal portion is the adsorbent coating rate (CR), and the ratio of the remaining area to the area of the metal portion is the adsorbent deficiency rate (DR).

Furthermore, three plates of the small cryopanel 60 have the same diameter. The reason why the top plate (the plate number 1) which is closest to the opening in the first group has an area larger than that of the right below plate (the plate numbers 2 and 3) is because the plate numbers 2 and 3 have the notch portion 88 illustrated in FIG. 6, but the top plate does not have the notch portion. That is, the area of the top plate increases as much as the area corresponding to the notch portion 88.

With regard to the front surface of the plate, as in the embodiment illustrated in FIG. 6, the charcoal adheres to the inside of the boundary which is determined by an intersection between the front surface of the plate and the visual line from the front shield end 33 to the front adjacent plate end. However, the front surface of the top plate (the plate number 1) which is closest to the opening in the first group is not provided with the charcoal, and the metallic surface is exposed. With regard to the right below plate (the plate number 2), the front surface is not provided with the charcoal and the metallic surface is exposed. This is because the visual line from the front shield end 33 does not intersect the plate surface (that is, the entire area of the front surface is visible from the front shield end 33).

The plates in which the charcoal occupies the entire area on the inside of the boundary determined by the visual line, correspond to: the plate which is farthest from the opening in the first group (the plate number 3); the plate which is closest to the opening in the second group (the plate number 4); the plate which is secondly closest to the opening in the second group (the plate number 5); the plate which is closest to the opening in the third group (the plate number 8); and the plate which is secondly closest to the opening in the third group (the plate number 9).

From the viewpoint of the manufacturing efficiency, two lower plates of the second group (the plate numbers 6 and 7) are the same as the right above plate (the plate number 5), and the lowermost plate of the third group (the plate number 10) is the same as the right above plate (the plate number 9). Accordingly, in these plates, the outer periphery of the actual charcoal portion is set at the slightly inside of the boundary determined by the visual line. Even in these plates, the charcoal portion may be widened so as to match the boundary determined by the visual line.

With regard to the rear surface of the plate, unlike the embodiment illustrated in FIG. 7, the outer peripheral end is not provided with the charcoal-free region and the charcoal adheres to the entire area. Accordingly, the area of the charcoal portion is equal to the area of the metal portion of the rear surface.

In the subtotal of the respective groups illustrated in FIG. 9, the charcoal coating rate gradually increases. Specifically, the charcoal coating rate of the first group is 50%, the charcoal coating rate of the second group is 77%, and the charcoal coating rate of the third group is 87%. In the entire cryopanel assembly 14, the charcoal coating rate is 76%.

As illustrated in FIGS. 2 and 4, one rear surface and the other front surface of two adjacent cryopanels 50 extend in parallel toward the side surface of the radiation shield 16, and an open recess 54 is formed therebetween. The open recess 54 faces the radiation shield 16, and is continuous to the open space 30. The outer peripheral side of the open recess 54 is a gas inlet which is continuous to the open space 30, and the inner peripheral side of the open recess 54 is blocked by two adjacent cryopanels 50 and the panel attachment member 52.

The cryopanels 50 are densely arranged in the axial direction of the shield so that the depth of the open recess 54 becomes larger than the gap between two adjacent cryopanels 50. The “depth” of the open recess 54 is the length of the cryopanel 50 in the inplane direction, and is a distance from the outer peripheral end of the cryopanel to the panel attachment member 52. When the sizes of two adjacent cryopanels 50 are different from each other, the distance from the outer peripheral end of the small cryopanel to the panel attachment member 52 is the depth of the open recess 54. Due to the dense panel arrangement, the larger amount of the adsorbent may be provided in the limited space inside the cryopump.

Since the adsorption region is formed on the surface of the cryopanel 50 which surrounds the open recess 54, at least 90% of the adsorbent and desirably substantially entire adsorbent is exposed toward the radiation shield 16 or the shield opening 31. The gas molecules which fly toward the cryopump 10 pass through the open region 35 around the louver 32 and enter the inner open space 30. A non-condensable gas such as hydrogen is reflected by the shield surface or the panel surface, enters the open recess 54, and reaches the adsorbent. The open state inside the cryopump continuous from the open region 35 to the open recess 54 through the open space 30 promotes the external gas to reach the adsorption region. In this way, the cryopump 10 with a high capture probability of hydrogen, for example at least a 30% capture probability, may be realized.

The hydrogen capture probability is given by the ratio of the actual hydrogen pumping speed with respect to the theoretical maximal hydrogen pumping speed in a cryopump having the same diameter (that is, the same cryopump opening area) as that of the cryopump 10. The actual hydrogen pumping speed of the cryopump may be obtained by the known Monte-Carlo simulation.

Further, the theoretical hydrogen pumping speed may be regarded to be the same as the conductance of the molecular flow through the opening. The conductance of hydrogen C_{hydrogen} is obtained by the following equation based on the conductance of air of 20° C., C_{20° C. air}.

$${C}_{hydrogen} = \sqrt{\frac{T}{293.15}} \times \sqrt{\frac{28.8}{M}} \times {C}_{20 ° C . air}$$

Here, T denotes the temperature (K) of the hydrogen gas, and M denotes the molecular weight (that is, M=2) of hydrogen. The conductance of air of 20° C. (C_{20° C. air}) is proportional to the opening area A (m²), and is given by C_{20° C. air}=116A. For example, in a case of the cryopump diameter of 250 mm, the theoretical hydrogen pumping speed is about 20, 840 L/s by the above-described equation. In this case, the condition that the hydrogen capturing probability is 30% is equivalent to the condition that the hydrogen pumping speed of the cryopump is about 6,252 L/s.

A typical cryopump of the related art which is used for high speed evacuation of hydrogen is designed based on the concept in which the pumping speed is increased by mounting the more cryopanels, that is, the larger amount of charcoal on the cryopump. Accordingly, a trade-off relation is found between an increase in the pumping speed and an increase in the panel weight and hence in the regeneration time (particularly, the cool-down time). In order to suppress an increase in the cool-down time while increasing the pumping speed, a refrigerator with high cooling performance is needed. For this reason, improvement in the energy saving performance may be sacrificed by an increase in the pumping speed.

On the contrary, an embodiment of the invention provides a new concept in which the hydrogen pumping efficiency is optimized in the cryopump for high speed hydrogen evacuation. The inventor defines a ratio between the hydrogen pumping speed (L/s) of the cryopump and the area of the adsorption region (mm²), that is, the pumping speed per unit area of the adsorbent-placed region as the hydrogen pumping efficiency (L/s·mm²) of the cryopump. Instead of simply increasing the amount of the adsorbent, the pumping efficiency can be improved to some extent by decreasing the area of the adsorption region. As described above, the area of the adsorption region may be decreased in the outer peripheral portion or any other portion of the cryopanel.

When the area of the adsorption region is decreased to a certain extent, the hydrogen pumping speed of the cryopump is decreased to a certain extent accordingly. However, it may be expected insignificant in a practical use. Even if individual cryopumps differ in pumping speed, the resultant difference in pumping speed that appears during a practical cryopump operation may tend to become smaller than the original difference. This is because the pumping speed and performance in a stand-alone cryopump are not directly exhibited due to a dominant limitation of the conductance of the vacuum chamber.

According to the experience and the examination of the inventor, if the individual cryopumps for high speed hydrogen evacuation are provided within a 10% difference therebetween in performance of the pumping speed, no critical influence on the pumping performance may be found with any one of these cryopumps when mounted on the vacuum chamber. Accordingly, when an allowable range of a decrease in the hydrogen pumping speed is set to be within 10%, an advantageous improvement in the hydrogen pumping efficiency by decreasing the area of the adsorption region may overcome the disadvantage of decreasing the pumping speed. Therefore, in an embodiment of the invention, the area of the adsorption region may be adjusted so that an enhanced pumping efficiency of hydrogen is obtained under a condition that the pumping speed of hydrogen is given as at least 90% of the pumping speed in the case of the entire coverage of the cryopanel by the adsorbent.

According to the analysis of the inventor, for example, in the cryopump with an array of a plurality of flat panels which are parallel to the opening as illustrated in FIGS. 2 and 4, when the entire surface of the cryopanel is covered by the adsorbent, the hydrogen pumping efficiency may remain from 2×10⁻² L/s·mm² to 4×10⁻² L/s·mm². On the contrary, when the adsorbent-free portion is provided as in the embodiments illustrated in FIGS. 2 and 4, the hydrogen pumping efficiency may be improved to 5×10⁻² L/s·mm² or more. In the allowable range of a decrease in the hydrogen pumping speed, the hydrogen pumping efficiency may be improved to 7×10⁻² L/s·mm².

That is, the hydrogen pumping efficiency may become approximately twice. This means that the hydrogen pumping speed of the same level is realized in the approximately half area of the adsorption region. Accordingly, the panel weight may be decreased by about 1,000 to 2,000 g. When the panel weight decreases, the cool-down time is also shortened. As a result, the average power consumption for regeneration may be decreased by approximately 40%.

Furthermore, in order to improve the hydrogen pumping efficiency so as to be higher than 7×10⁻² L/s·mm², it is realistic to adopt a cryopanel assembly of a type in which an adsorbent is completely exposed (for example, see Japanese Patent Application Laid-Open No. 2009-162074). The entire content of Japanese Patent Application Laid-Open No. 2009-162074 is incorporated herein by reference.

Incidentally, molecules of a condensable gas which fly toward the cryopump 10 from the outside pass through the open region 35 around the louver 32, reach the radiation shield 16 or the condensation region on the outer periphery of the cryopanel 50 along a straight path, and are captured on the surface thereof. The open local space 54 is optically shielded by the upper cryopanel 50 from the cryopump opening 31 except for a gas inlet at the outer peripheral side, and the adsorption region is accommodated in the shielded portion. Hardly regenerated gases are mostly condensable gases. Since the direct exposure of the adsorption region toward the cryopump opening 31 is prevented, the adsorption region is protected from the hardly regenerated gas which is contained in the gas entering the cryopump 10. The hardly regenerated gas is accumulated in the condensation region. In this way, it is possible to rapidly evacuate the non-condensable gas and protect the adsorption region from the hardly regenerated gas.

In an embodiment of the invention, the adsorption region is accommodated in the shielded portion, and is not visible from the cryopump opening 31. In other words, the “adsorbent visible rate” which is a ratio of the adsorbent area which is visible from the cryopump opening 31 with respect to a gross area of the adsorbent on the cryopanel 50 is 0%. However, the cryopump according to an embodiment of the invention is not limited to the configuration in which the adsorbent visible rate is 0%. When the adsorbent visible rate is less than 7%, it may be evaluated that the adsorbent is substantially invisible from the opening. In an embodiment, it is desirable that the adsorbent visible rate is less than 7%, less than 5%, or less than 3%. However, for example, when it is expected that the content ratio of the hardly regenerated gas is sufficiently low or the exposed adsorbent is allowed to be sacrificed, 7% or more of the adsorbent may be visible from the opening.

Compared to a cryopanel 50 which is close to the cryopump opening 31, gas molecules hardly reach a cryopanel 50 inside the radiation shield 16 distant from the cryopump opening 31. The contribution to the pumping speed of the cryopanel 50 distant from the cryopump opening 31 is small, and the influence of the hardly regenerated gas is small. Accordingly, in an embodiment, the adsorbent may be provided in the exposed peripheral edge portion of the lower large cryopanel 64. For example, when the adsorbent is provided in the entire area of the front surface of the large cryopanel 64 in the embodiment illustrated in FIG. 8, the adsorbent visible rate is about 7%.

The operation of the cryopump 10 will be described. In order to initiate the operation of the cryopump 10, the inside of the vacuum chamber 80 is adjusted to be about from 1 Pa to 10 Pa by using an appropriate roughing pump before the operation. Subsequently, the cryopump 10 is operated. When the refrigerator 12 is driven, the first cooling stage 22 and the second cooling stage 24 are cooled, and the radiation shield 16, the louver 32, and the cryopanel assembly 14 which are thermally connected thereto are also cooled. The first cryopanel includes the radiation shield 16 and the louver 32, and the second cryopanel includes the cryopanel assembly 14.

The cooled louver 32 cools gas molecules which fly from the vacuum chamber 80 into the cryopump 10, condenses a gas with a sufficiently low vapor pressure at the cooling temperature on the surface thereof (for example, moisture or the like), and evacuates the gas. A gas of which the vapor pressure does not sufficiently decreases at the cooling temperature of the louver 32 passes through the louver 32 and enters the radiation shield 16. Of the gas molecules which pass through the louver 32, a gas of which a vapor pressure sufficiently decreases at the cooling temperature of the cryopanel assembly 14 (for example, argon or the like) is condensed and evacuated on the surface of the cryopanel assembly 14. A gas of which a vapor pressure does not sufficiently decreases even at the cooling temperature (for example, hydrogen or the like) is adsorbed and evacuated onto the cooled adsorbent that adheres to the surface of the cryopanel assembly 14. In this way, the cryopump 10 may achieve the vacuum degree inside the vacuum chamber 80 to a desired level.

Especially, in the cryopump 10 which is used for an evacuation system of an ion implantation apparatus, a hardly regenerated gas such as an organic gas or a dopant gas in the gas which enters the radiation shield 16 is condensed in the adsorbent-free portion of the cryopanel 50. A gas, such as a hydrogen gas, the molecule diameter which is comparatively small is adsorbed to the adsorbent. In this way, the cryopumping process is performed.

When the cryopumping process is continuously performed, a gas is accumulated inside the cryopump. A regenerating process is performed so as to discharge the accumulated gas to the outside. First, the gate valve 7 is closed so as to isolate the cryopump 10 from the vacuum chamber 80. Then, the temperature of the cryopanel 50 is raised. The temperature of the cryopanel 50 increases to a temperature higher than the cooling temperature in the cryopumping process (for example, a room temperature).

In accordance with an increase in the temperature, the captured gas by condensation on the surface of the cryopanel evaporates, while the captured gas by adsorption is released again through desorption into the pump casing. The evaporated and released gases are discharged to the outside through the discharge port (not illustrated) of the cryopump 10 by, for example, the driving of the associated roughing pump. Subsequently, the cryopanel 50 is cooled again at the operation temperature in the cryopumping process. After the cooling, the regenerating process is completed. The gate valve 7 is opened, so that the cryopumping process is started again. In this way, the cryopumping process and the regenerating process are alternately performed.

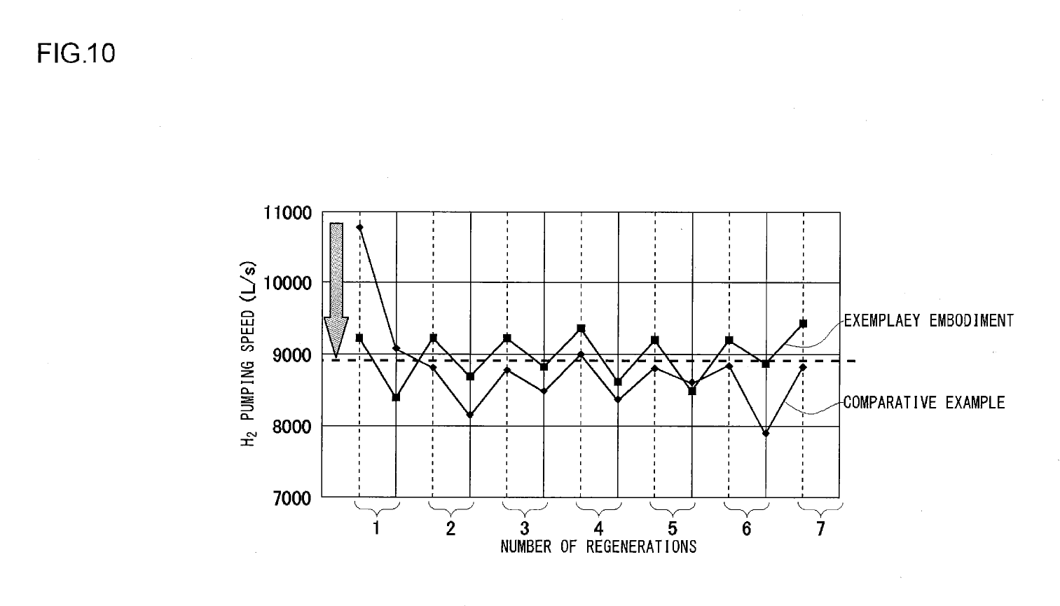

FIG. 10 is a diagram illustrating a change in the hydrogen pumping speed of a cryopump through regeneration processes according to an embodiment of the invention. FIG. 10 illustrates a change in the hydrogen pumping speed of the cryopump 10 according to an embodiment of the invention. For comparison, for example, it illustrates a change in the hydrogen pumping speed of a cryopump with a cryopanel assembly of a type in which an adsorbent is completely exposed disclosed in Japanese Patent Application Laid-Open No. 2009-162074. The vertical axis of FIG. 10 indicates the measurement value of the hydrogen pumping speed, and the horizontal axis indicates the number of regenerations. The pumping speed measurement value on the solid vertical line is a value immediately before the regenerating process, and the pumping speed measurement value on the dashed vertical line is a value immediately after the completion of the regeneration process.

The measurement value on the dashed line at the first regeneration illustrated in FIG. 10 is a value when the cryopump is first operated. Since the charcoal is not contaminated by any hardly regenerated gas, a particularly high hydrogen pumping speed is illustrated for the complete exposure type of the comparative example.

It is estimated that the pumping speed is low immediately before the regeneration and is recovered after the completion of the regeneration. However, as illustrated in the comparative example, a decrease in the pumping speed and the recovery thereof are repeated only after the third regeneration, but the pumping speed decreases continuously from the initial high pumping speed until the second regeneration. It is considered that the pumping speed is continuously decreased until the exposed charcoal is contaminated to a certain extent. Even in the subsequent regeneration, the pumping speed is not recovered to the initial pumping performance.

In the shown embodiment, however, an increase and a decrease in the pumping speed are repeated through regenerations from the first regeneration to the seventh regeneration. Even when the regeneration is repeated, the hydrogen pumping speed is substantially maintained at a constant level as depicted by the horizontal bold dashed line illustrated in the figure. The initial pumping performance is recovered by each regeneration. That is, the stable pumping performance may be continuously maintained from the initial operation immediately after the shipment of the cryopump.

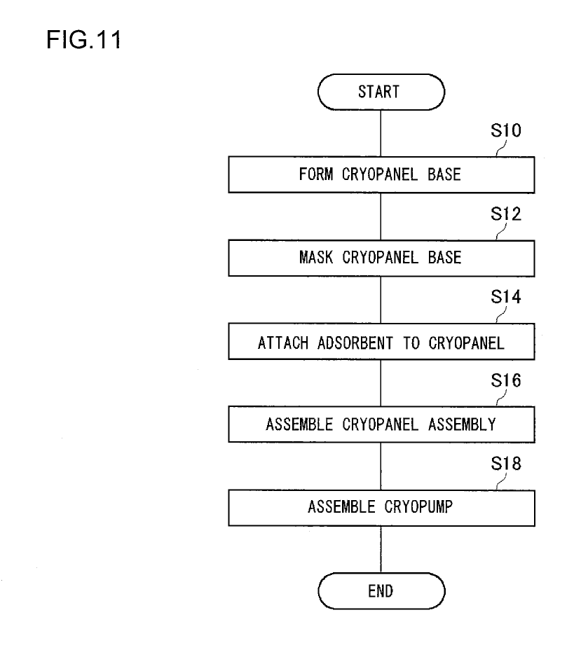

FIG. 11 is a flowchart illustrating a method of manufacturing the cryopump 10 according to an embodiment of the invention. This method is performed by the operator or the manufacturing device in the process of manufacturing the cryopump 10. Before a masking process, a process is performed which processes and forms a base or substrate of a cryopanel from a base material (S10). As illustrated in FIG. 11, the masking process is performed on the base of the cryopanel 50 (S12). The masking process includes masking an optically exposed portion of the base which is not shielded by the other cryopanel (for example, the adjacent upper cryopanel when the cryopanel assembly 14 is assembled). The masking process includes attaching, for example, a masking tape to the exposed portion.

Next, an adsorbent attaching process is performed in which the adsorbent is attached to the unmasked surface of the base (S14). The attaching process includes applying an adhesive to the unmasked surface of the base and attaching an adsorbent, for example, particle-like charcoal to the adhesive region. The cryopanel 50 with the adsorbent is mounted to the panel attachment member 52, and the cryopanel assembly 14 is assembled (S16). The cryopanel assembly 14 is mounted to the refrigerator 12 of the cryopump 10, and the cryopump 10 is assembled (S18).

Further, before the masking process, a process may be performed which determines a masked region on each cryopanel 50. The masked region may be the outside of the boundary defined by the intersection between the cryopanel 50 and the visual line from the front end of the radiation shield 16 to the end of the cryopanel 50 adjacent to that cryopanel 50. The determining process may be performed in the designing process at the front stage of the manufacturing process.

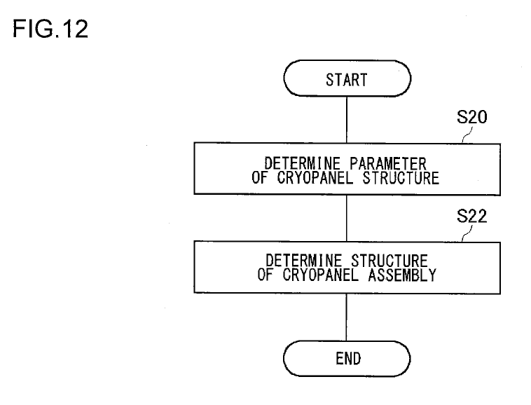

FIG. 12 is a flowchart illustrating a method of manufacturing the cryopump 10 according to an embodiment of the invention. This method is performed in a design process of, for example, the cryopanel assembly 14. First, a value of the cryopanel structure parameter is obtained which generates the maximal hydrogen pumping speed in a range of the cryopanel structure parameter under certain constraints (S20). The value of the panel structure parameter which generates the maximal hydrogen pumping speed may be obtained by using a known method of experimental design in which the panel structure parameter is set as a variable and the hydrogen pumping speed is set as an objective function.

The constraints include a condition that the adsorbent is absent from a part of the surface of the cryosorption panel. The adsorbent deficiency condition may be set so that the adsorption region is formed on the inside of the boundary determined by the intersection between the front surface of a certain cryopanel and the visual line from the front end of the radiation shield 16 to the peripheral end of the cryopanel 50 adjacent to that cryopanel 50.

The panel structure parameter includes the dimension of the cryosorption panel, for example, the diameter of the panel when the panel has a circular shape. When the cryopanel assembly 14 includes a plurality of cryopanels with different shapes, a plurality of parameters representing the respective shapes may be used. When the cryopanel assembly 14 includes a plurality of cryopanel with different diameters, the panel structure parameter may include the diameters thereof. The panel structure parameter may include the gap between the cryopump opening 31 and the top panel. The panel structure parameter may include the diameter of the louver 32. The panel structure parameter may include the gap between the adjacent cryopanels.

The configuration of the cryosorption panel arrangement is determined based on the value of the panel structure parameter obtained in this way (S22). For example, the cryopanel dimension, for example, the value of the panel diameter is obtained which generates the maximal hydrogen pumping speed under the condition that the adsorbent is absent from a part of the surface of the cryosorption panel. The specific configuration of the cryopanel assembly 14 may be determined by using the value.

The present invention has been described above based on the embodiments. It should be appreciated by those skilled in the art that the invention is not limited to the above embodiments but various design changes and variations can be made, and such variations are also encompassed by the present invention.

A panel arrangement which is different from that of the above-described embodiment may be adopted. For example, the gaps between the cryopanels may be the same for all panels, and each gap may be different. For example, the plurality of panels 50 may be respectively disposed so that the gap between the panels is narrowed as the position of the panel is distant away from the opening 31. In this way, a gas may satisfactorily flow in a volume close to the opening 31, and the pumping speed thereof may be increased. Additionally, when the panels are relatively densely arranged in a volume distant from the opening 31, the area of the adsorption region may be increased, so that the sufficient gas adsorption amount may be ensured.

Further, the cryopanel 50 with a shape and/or an orientation different from that of the above-described embodiment may be adopted. For example, the length of the panel 50 in the radial direction may be shortened as the position of the panel is away from the opening 31, or the lengths of the panels 50 may be equal to each other. The shape of the panel 50 when seen from the opening 31 may not be a circular shape, for example, may be any other shape such as a polygonal shape. The peripheral edge portion of the panel 50 may be provided with, for example, a bent portion which is formed upward or downward. The surface of the panel 50 may be provided with an opening or a slit which promotes the flow of a gas therethrough. The panel 50 may be directed in an inclined manner so as to be away from the opening 31 as it extends outwardly in the radial direction, and may be inclined so as to be closer to the opening 31 as it extends outwardly in the radial direction.

For example, in the cryopanel assembly 14, the exposed surface other than the cryopanel 50 may be used as the adsorbent attachment surface. For example, the panel attachment member 52 may be used as one of cryopanels.

It should be understood that the invention is not limited to the above-described embodiment, but may be modified into various forms on the basis of the spirit of the invention. Additionally, the modifications are included in the scope of the invention

Priority is claimed to Japanese Patent Application No. 2011-107670, filed May 12, 2011, the entire content of which is incorporated herein by reference.

What is claimed is:

1. A cryopump comprising:
a refrigerator comprising a first cooling stage providing a first cooling temperature and a second cooling stage providing a second cooling temperature for adsorption of a non-condensable gas, the second temperature lower than the first temperature;
a radiation shield comprising a shield end forming a gas receiving opening, the radiation shield thermally connected to the first cooling stage and surrounding the second cooling stage; and
a cryopanel assembly thermally connected to the second cooling stage and forming an open space to the opening between the radiation shield and a peripheral portion of the assembly, at least a part of the assembly being visible from the shield end,
wherein the cryopanel assembly comprises: a top panel facing the opening; and an intermediate panel disposed opposite to the opening with respect to the top panel and comprising a front surface directed to the opening,
wherein a peripheral part of an adjacent cryopanel facing the front surface of the intermediate panel and a portion of the front surface facing the peripheral part extend toward the radiation shield in the open space in substantially parallel with each other,
wherein the front surface is divided into an adsorption region of a non-condensable gas and a condensation region of a condensable gas.

2. The cryopump according to claim 1, wherein the adjacent cryopanel is the top panel, and a peripheral part of the intermediate panel extends closer to the radiation shield than the peripheral part of the top panel.

3. The cryopump according to claim 1, wherein both the top panel and the intermediate panel comprises a plurality of plates arranged in parallel with each other, each plate comprising a front face directed to the opening and a rear face directed opposite to the opening, a dimension of the plates of the intermediate panel larger than that of the plates of the top panel.

4. The cryopump according to claim 1, wherein the cryopanel assembly further comprises a lower panel disposed opposite to the opening with respect to the intermediate panel, a peripheral part of the lower panel extends substantially parallel to the intermediate panel, the peripheral part of the lower panel lying closer to the radiation shield than a peripheral part of the intermediate panel.

5. The cryopump according to claim 4, wherein the lower panel comprises a plurality of plates arranged in parallel with each other, each comprising a front face directed to the opening and a rear face directed opposite to the opening, a dimension of the plates of the lower panel larger than that of the plates of the intermediate panel.

6. The cryopump according to claim 1, wherein an open recess continuous to the open space is formed between the portion of the front surface of the intermediate panel and the peripheral part of the adjacent cryopanel, a depth of the open recess larger than a gap between the adjacent cryopanel and the front surface.

7. The cryopump according to claim 1, wherein a peripheral part of the front surface is divided into the adsorption region of the non-condensable gas and the condensation region of the condensable gas.

8. The cryopump according to claim 1, further comprising:
a louver thermally connected to the radiation shield and disposed in the opening,
wherein the louver has a medium size between the sizes of the top panel and the intermediate panel, and an open region is formed between an outer end of the louver and the radiation shield.

9. The cryopump according to claim 1, wherein the cryopump has at least a 30% capture probability of hydrogen,
wherein the intermediate panel comprises a cryopanel base to support an adsorbent thereon, the adsorbent capable of adsorbing hydrogen, the cryopanel base having at most a 30% area of a total surface of the cryopanel base from which the adsorbent is absent, such that an improved pumping efficiency of hydrogen, the efficiency defined as a ratio between a hydrogen pumping speed and an adsorbent area of the cryopump, is obtained compared to a case where the total surface of the cryopanel base would be covered entirely with the adsorbent.

10. A cryopump comprising:
a radiation shield; and
a cryopanel assembly comprising a plurality of cryopanels arranged inside the radiation shield toward a bottom thereof, the assembly forming an open space connected to a radiation shield opening between peripheral parts of the plurality of cryopanels and the radiation shield,
wherein the cryopump has at least a 30% capture probability of hydrogen,
wherein each of the plurality of cryopanels comprises a cryopanel base to support an adsorbent thereon, the adsorbent capable of adsorbing hydrogen, the cryopanel base having at most a 30% area of a total surface of the cryopanel base from which the adsorbent is absent, such that an improved pumping efficiency of hydrogen, the efficiency defined as a ratio between a hydrogen pumping speed and an adsorbent area of the cryopump, is obtained compared to a case where the total surface of the cryopanel base would be covered entirely with the adsorbent.

11. The cryopump according to claim 10, wherein the pumping efficiency of hydrogen is 5×10⁻² L/s·mm² or more.

12. The cryopump according to claim 10, wherein at least a 10% area of the total surface of the cryopanel base is an adsorbent-free region.

13. The cryopump according to claim 10, wherein at least 90% of the adsorbent is exposed to the radiation shield or the opening.

14. A method of manufacturing a cryopump, comprising:
obtaining a value of a panel structure parameter to provide a maximal pumping speed of hydrogen during a change of the panel structure parameter under a condition that a part of a surface of a cryosorption panel from which an adsorbent is absent is arranged; and
determining a configuration of a cryosorption panel arrangement based on the value of the panel structure parameter.

15. The method according to claim 14, wherein the panel structure parameter includes a dimension of the cryosorption panel.
